(19) United States
(12) Patent Application Publication
(10) Pub. No.: US 2011/0312240 A1
(43) Pub. Date: Dec. 22, 2011

(54) AQUEOUS BINDER COMPOSITIONS

(75) Inventors: Stephan Amthor, Ludwigshafen (DE); Bernd Reck, Gruenstadt (DE); Jens Hartig, Ludwigshafen (DE)

(73) Assignee: BASF SE, Ludwigshafen (DE)

(21) Appl. No.: 13/161,825

(22) Filed: Jun. 16, 2011

Related U.S. Application Data
(60) Provisional application No. 61/355,637, filed on Jun. 17, 2010.

(51) Int. Cl. D04H 13/00; C09J 133/24; C09D 133/24; C08L 39/00; C08F 226/02

(52) U.S. Cl. 442/327; 524/831; 525/328.4

(57) ABSTRACT

The present invention relates to aqueous binder compositions which are based on aqueous polymer dispersions, to processes for preparing them, and to their uses. The aqueous binder composition comprises:
a) a water-insoluble polymer P in the form of dispersed polymer particles, i.e., in the form of an aqueous polymer dispersion, the polymer P being obtainable by polymerization of ethylenically unsaturated monomers M, the monomers M comprising:
   90% to 99.9% by weight, more particularly 92% to 99.5% by weight and especially 93% to 99% by weight, based on the total amount of monomers M, of at least one neutral, monoethylenically unsaturated monomer M1 of low water-solubility; and
   0.1% to 10% by weight, more particularly 0.5% to 7% by weight and especially 1% to 5% by weight, based on the total amount of monomers M, of at least one monoethylenically unsaturated monomer M2 which is selected from monoethylenically unsaturated monomers which have at least two hydroxyl groups attached to vicinal C atoms, and monomers which carry a functional group which can be converted by hydrolysis into two hydroxyl groups attached to vicinal C atoms;
      and
b) boric acid and/or at least one salt of boric acid.

The present invention relates to aqueous binder compositions which are based on aqueous polymer dispersions, to processes for preparing them, and to their uses.

Aqueous polymer dispersions which form polymer films when the aqueous dispersion medium is evaporated have found widespread use. They are used, for example, as aqueous binder systems in paints, in varnishes, in paper coating slips, in leather coating systems, in coating systems for mineral moldings such as fiber cement slabs and concrete roofing shingles, in anticorrosion primers for metals, as binders in nonwovens production, as base materials for adhesives, as additives for hydraulically setting compositions such as plaster or concrete, as additives for clay or loam construction materials, for producing membranes and the like. The solid polymer compositions in particle or powder form that are obtainable from such aqueous dispersions by drying may likewise be employed, and serve, moreover, as additives for a large multiplicity of application fields, such as for modifying plastics, as cement additives, as components of toner formulations, as additives in electrophotographic applications, and the like. Aqueous polymer dispersions of this kind are typically prepared by a free-radical aqueous emulsion polymerization of ethylenically unsaturated monomers.

It has emerged that polymer dispersions having crosslinked polymer chains possess properties that are advantageous for many of such applications. The polymer chains may be crosslinked either during or after the emulsion polymerization. The former is referred to as internal, the latter as external crosslinking. Examples of internal crosslinking are free-radical polymerizations of monounsaturated monomers in the presence of polyunsaturated monomers, which function as crosslinking agents. In the case of external crosslinking, polymers which have particular functional or reactive groups are generally crosslinked by irradiation or by addition of a crosslinking agent which reacts with the functional/reactive groups of the polymer to form a coordinative or covalent bond. The nature of the crosslinking agent is guided by the nature of the functional group in the polymer. For example, ionic crosslinking agents such as, in particular, zinc salts and calcium salts can be used for crosslinking polymers which have carboxyl groups. Polymers with aldehyde or keto groups or with oxirane groups can be crosslinked, for example, with organic compounds which have two or more primary amino groups or hydrazide groups. The addition of such crosslinking agents, however, is not possible in all cases. Polymers with hydroxyl or amino groups can be crosslinked, for example, with di- or polyisocyanates. A disadvantage found is that the polymer dispersions may become unstable as a result of the addition of the isocyanate crosslinking agent. Because of the irreversibility of the crosslinking reaction, the shelf life of such dispersions is limited, and, when binders of this kind are used, there may therefore be problems affecting the application.

EP 1 419 897 describes recording materials for inkjet printers that have an ink-receiving layer comprising a water-soluble or water-dispersible polymer. The polymer contains a repeating monomer unit which is capable of chelating boric acid by means of a nitrogen-containing functional group and a hydroxyl group, by forming a 5- or 6-membered ring. The possible applications of the polymer dispersions described are very limited, and in particular they are not suitable as binders for paints or for fiber binding or for adhesive raw material.

U.S. Pat. No. 4,544,699 describes an adhesive composition which comprises an aqueous dispersion of a copolymer, prepared from vinylidene chloride and a monomer having a hydroxyl group, and also comprises a crosslinking agent, which can be boric acid or salts of boric acid. As a result of the high proportion of vinylidene chloride and the restriction to crosslinking mediated by hydroxyl groups, the compositions are suitable only for very specific adhesive applications.

It is an object of the present invention to provide binders that are based on aqueous polymer dispersions and have improved performance properties.

Surprisingly it has been found that this and further objects are achieved by binder compositions based on aqueous polymer dispersions whose polymers comprise small amounts, e.g., 0.1% to 10% by weight, based on the polymer, of monoethylenically unsaturated monomers having vicinal hydroxyl functions and/or monomers having functional groups from which vicinal hydroxyl groups can be liberated by hydrolysis, when the binder composition comprises boric acid and/or a boric salt.

The invention accordingly first provides an aqueous binder composition comprising
a) a water-insoluble polymer (P) in the form of dispersed polymer particles, i.e., in the form of an aqueous polymer dispersion, the polymer P being obtainable by polymerization of ethylenically unsaturated monomers M, the monomers M comprising:
   90% to 99.9% by weight, more particularly 92 to 99.5% by weight and especially 93 to 99% by weight, based on the total amount of monomers M, of at least one neutral, monoethylenically unsaturated monomer M1 of low water-solubility; and
   0.1% to 10% by weight, more particularly 0.5 to 7% by weight and especially 1 to 5% by weight, based on the total amount of monomers M, of at least one monoethylenically unsaturated monomer M2 which is selected from monoethylenically unsaturated monomers which have at least two hydroxyl groups attached to vicinal C atoms, and monoethylenically unsaturated monomers which carry a functional group which can be converted by hydrolysis into two hydroxyl groups attached to vicinal C atoms;
      and
b) boric acid and/or at least one salt of boric acid.

The polymers and aqueous polymer dispersions present in the binder compositions of the invention are new when the monomers M2 are selected from monoethylenically unsaturated monomers which have at least two hydroxyl groups attached to vicinal C atoms.

The present invention accordingly also provides aqueous polymer dispersions of a water-insoluble polymer (P) which is obtainable by polymerization of ethylenically unsaturated monomers M, the monomers M comprising:
90% to 99.9%, more particularly 92% to 99.8% and especially 93% to 99.5%, by weight, based on the total amount of monomers M, of at least one neutral, monoethylenically unsaturated monomer M1 of low water-solubility; and
0.1% to 10%, more particularly 0.2% to 7% and especially 0.5% to 5%, by weight, based on the total amount of monomers M, of at least one monoethylenically unsaturated monomer M2 which is selected from monoethylenically unsaturated monomers which have at least two hydroxyl groups attached to vicinal C atoms.

All observations made concerning the polymer (P) and the monomers M from which the polymer (P) is constructed relate both to the aqueous binder composition which comprises boric acid or boric salts and to the aqueous polymer dispersion of the polymer (P) and to solid binder compositions comprising the polymer (P) in the form of a powder and also boric acid and/or at least one salt of boric acid.

The invention further provides a solid binder composition which comprises a water-insoluble polymer (P) as defined here and below, in the form of a powder, and also boric acid and/or at least one salt of boric acid.

The binder compositions of the invention are suitable for a multiplicity of applications in which binder compositions based on aqueous polymer dispersions are used. For instance, the binder compositions of the invention are suitable as binders for consolidating nonwovens, where they result in a combination of high flexibility with improved water resistance. When used as binders in coating compositions, they result in enhanced blocking resistance on the part of the coating, a quality which is retained even at elevated temperature, without any notable decrease in the flexibility of the coating. Through the use of the binder compositions of the invention as adhesive raw materials, moreover, it is possible to obtain adhesives having generally good adhesion and cohesion properties that are advantageously harmonized with one another, said compositions enjoying high storage stability even in the form of one-component formulations. Moreover, the binder compositions of the invention endow hydraulically setting binders such as cements and plasters, and the hydraulically setting compositions prepared therefrom such as concrete, mortar or cement coatings, with enhanced physical properties, especially improved strength, such as tensile and breaking strength, and enable coatings to have high adhesion and good abrasion resistance.

The present invention accordingly further provides for the use of binder compositions as defined above in coating materials, in particular in surface coating materials, printing inks and textile coatings.

The present invention further provides for the use of binder compositions as defined above in adhesives.

The present invention further provides for the use of binder compositions as defined above in sealing compounds.

The present invention further provides for the use of binder compositions as defined above for application in hydraulically setting binders, such as plaster or cement, particularly for application in cement, i.e., as a modifying additive in inorganic, hydraulically setting binders, especially in cement and the binding construction materials produced therefrom such as concrete, mortar or cement coatings.

The present invention further provides for the use of binder compositions as defined above for producing polymer-consolidated nonwoven fabrics or nonwovens.

The invention further provides for the uses of boric acid and/or at least one salt of boric acid to modify the properties of a polymer-bound coating comprising as binder a water-insoluble polymer (P) and also for the use of boric acid and/or at least one salt of boric acid to modify the properties of an adhesive which comprises a water-insoluble polymer (P).

In the adhesives or in the binder compositions or in the coating materials used to produce the coatings, said water-insoluble polymers (P) are present in the form of dispersed polymer particles. The water-insoluble polymers (P) are typically obtainable by free-radical aqueous emulsion polymerization of ethylenically unsaturated monomers M, the monomers M comprising the monomers specified above and below in the quantities indicated there.

The invention further provides processes for preparing the binder compositions of the invention, comprising the steps of
A) preparing an aqueous dispersion of a water-insoluble polymer (P) by polymerization of ethylenically unsaturated monomers M; and
B) adding boric acid and/or at least one salt of boric acid to the polymer dispersion obtained in step A) after or during its preparation.

Additionally provided by the invention are the coating compositions, especially paints, printing inks, and coating materials for textiles, and also adhesives, sealants, inorganic, hydraulically setting binder compositions, and nonwovens, that are described below and comprise a binder composition of the invention.

In the context of the present invention the expression “alkyl” comprises straight-chain and branched alkyl groups, especially having 1 to 30 carbon atoms, i.e., for “C₁-C₃₀ alkyl”.

Suitable short-chain alkyl groups are, for example, straight-chain or branched C₁-C₇ alkyl, preferably C₁-C₆ alkyl, and more preferably C₁-C₄ alkyl groups. These include, in particular, methyl, ethyl, propyl, isopropyl, n-butyl, 2-butyl, sec-butyl, tert-butyl, n-pentyl, 2-pentyl, 2-methylbutyl, 3-methylbutyl, 1,2-dimethylpropyl, 1,1-dimethylpropyl, 2,2-dimethylpropyl, 1-ethylpropyl, n-hexyl, 2-hexyl, 2-methylpentyl, 3-methylpentyl, 4-methylpentyl, 1,2-dimethylbutyl, 1,3-dimethylbutyl, 2,3-dimethylbutyl, 1,1-dimethyl-butyl, 2,2-dimethylbutyl, 3,3-dimethylbutyl, 1,1,2-trimethylpropyl, 1,2,2-trimethylpropyl, 1-ethylbutyl, 2-ethylbutyl, 1-ethyl-2-methylpropyl, n-heptyl, 2-heptyl, 3-heptyl, 2-ethylpentyl, 1-propylbutyl, etc.

Suitable longer-chain alkyl groups are, for example, straight-chain and branched C₈-C₃₀ alkyl groups, preferably C₈-C₂₀ alkyl groups. Preferably these are predominantly linear alkyl radicals, such as also occur in natural or synthetic fatty acids and fatty alcohols and also in oxo-process alcohols. They include, for example, n-octyl, n-nonyl, n-decyl, n-undecyl, n-dodecyl, n-tridecyl, n-tetradecyl, n-pentadecyl, n-hexadecyl, n-heptadecyl, n-octadecyl, and n-nonadecyl. The expression “alkyl” comprises unsubstituted and substituted alkyl radicals.

The above observations concerning alkyl also apply analogously to the alkyl groups in alkanol, alkylamine, and alkanecarboxylic acids.

The expression “alkylene” in the context of the present invention stands for straight-chain or branched alkanediyl groups having 1 to 7 carbon atoms, such as, for example, methylene, 1,2-ethylene, 1,2-propylene, 1,3-propylene, 1,2-butylene, 1,3-butylene, 1,4-butylene, 2-methyl-1,2-propylene, etc.

The binder composition of the invention comprises a water-insoluble polymer (P). In the case of an aqueous composition, the polymer is in the form of polymer particles which are in dispersion in an aqueous phase, i.e., in the form of an aqueous polymer dispersion. In the case of a solid composition, the polymer (P) is in the form of a powder, where the powder particles comprise the polymer (P).

The polymers (P) are obtainable by free-radical polymerization of ethylenically unsaturated monomers M. The monomers M constituting the polymer P comprise at least one neutral, monoethylenically unsaturated monomer M1 of low water-solubility, and at least one monoethylenically unsaturated monomer M2 which is selected from monoethylenically unsaturated monomers which have at least two hydroxyl groups attached to vicinal C atoms, and monoethylenically unsaturated monomers which carry a functional group which can be converted by hydrolysis into two hydroxyl groups attached to vicinal C atoms.

Boric acid in the context of this invention means the monomeric boric acid (ortho-boric acid B(OH)₃) and also its oligomeric condensation products (meta-boric acids), especially diboric acid, triboric acid, cyclotriboric acid, tetraboric acid, pentaboric acid, hexaboric acid, octaboric acid, decaboric acid, dodecaboric acid, and higher oligomers having generally up to 20 boron atoms. Boric salts, also called borates below, are here, correspondingly, the salts of monomeric boric acid (ortho-borates) and also the salts of oligomeric boric acids (meta-borates), more particularly their alkali metal salts, alkaline earth metal salts, ammonium salts, alkylammonium salts, and hydroxyalkylammonium salts, which optionally may comprise further anions, such as—for instance—halides, examples being the diborates, triborates, cyclotriborates, tetraborates, pentaborates, hexaborates, octaborates, decaborates, and dodecaborates, which may be present in anhydrous form or in hydrate form. An alkylammonium salt here is a mono-, di-, tri- or tetraalkylammonium salt whose alkyl radicals independently of one another have 1 to 10 and preferably 1 to 4 C atoms. A hydroxyalkylammonium salt here is a mono-, di-, tri- or tetraalkylammonium salt whose alkyl radicals have 1 to 10 and preferably 1 to 4 C atoms, with one or more alkyl radicals carrying at least one hydroxyl group.

Monomers M1 with low water-solubility are generally those monomers whose solubility in deionized water at 25° C. and 1 bar does not exceed 60 g/l and more particularly 30 g/l, and is situated typically in the range from 0.1 to 30 g/l (25° C., 1 bar).

The monomers M1 are neutral; that is, in an aqueous environment, they are neither protonated nor act as an acid.

The monomer M1 is monoethylenically unsaturated, i.e., has precisely one ethylenically unsaturated C═C double bond. The monomers M1 are preferably selected from esters and diesters of monoethylenically unsaturated C₃-C₈ monocarboxylic and C₄-C₈ dicarboxylic acids with C₁-C₃₀ alkanols, particularly with C₁-C₁₀ alkanols, esters of vinyl alcohol or allyl alcohol with C₁-C₃₀ monocarboxylic acids, vinylaromatics, amides and diamides, monoethylenically unsaturated C₃-C₈ monocarboxylic and C₄-C₈ dicarboxylic acids with C₁-C₃₀ alkylamines or di-C₁-C₃₀ alkylamines, especially with C₁-C₁₀ alkylamines or di-C₁-C₁₀-alkylamines, and mixtures thereof.

The term “monoethylenically unsaturated C₃-C₈ monocarboxylic acid” stands for a monovalent carboxylic acid having 3 to 8 C atoms that has an ethylenically unsaturated C═C double bond, such as for acrylic acid, methacrylic acid, vinylacetic acid or crotonic acid, for example.

The term “monoethylenically unsaturated C₄-C₈ dicarboxylic acid” stands for a divalent carboxylic acid having 4 to 8 C atoms that has an ethylenically unsaturated C═C double bond, such as for maleic acid, fumaric acid, itaconic acid or citraconic acid, for example.

Further suitable monomers M1 are, for example, vinyl halides, vinylidene halides, and mixtures thereof.

Suitable esters and diesters of monoethylenically unsaturated C₃-C₈ monocarboxylic and C₄-C₈ dicarboxylic acids with C₁-C₃₀ alkanols, especially with C₁-C₁₀ alkanols, are, in particular, the esters of monoethylenically unsaturated C₃-C₈ monocarboxylic acids, especially the esters of acrylic acid and the esters of methacrylic acid, with C₁-C₃₀ alkanols, in particular with C₁-C₁₀ alkanols, such as methyl (meth)acrylate, methyl ethacrylate, ethyl (meth)acrylate, ethyl ethacrylate, n-propyl (meth)acrylate, isopropyl (meth)acrylate, n-butyl (meth)acrylate, sec-butyl (meth)acrylate, tert-butyl (meth)acrylate, tert-butyl ethacrylate, n-hexyl (meth)acrylate, n-heptyl (meth)acrylate, n-octyl (meth)acrylate, 1,1,3,3-tetramethylbutyl (meth)acrylate, ethylhexyl (meth)acrylate, n-nonyl (meth)acrylate, n-decyl (meth)acrylate, n-undecyl (meth)acrylate, tridecyl (meth)acrylate, myristyl (meth)acrylate, pentadecyl (meth)acrylate, palmityl (meth)acrylate, heptadecyl (meth)acrylate, nonadecyl (meth)acrylate, arachidyl (meth)acrylate, behenyl (meth)acrylate, lignoceryl (meth)acrylate, cerotyl (meth)acrylate, melissyl (meth)acrylate, palmitoleyl (meth)acrylate, oleyl (meth)acrylate, linolyl (meth)acrylate, linolenyl (meth)acrylate, stearyl (meth)acrylate and lauryl (meth)acrylate, but also the diesters of monoethylenically unsaturated C₄-C₈ dicarboxylic acids, in particular the diesters of maleic acid with C₁-C₃₀ alkanols, such as dimethyl maleate, diethyl maleate, di(n-propyl) maleate, diisopropyl maleate, di(n-butyl) maleate, di(n-hexyl) maleate, di(1,1,3,3-tetramethylbutyl) maleate, di(n-nonyl) maleate, ditridecyl maleate, dimyristyl maleate, dipentadecyl maleate, dipalmityl maleate, diarachidyl maleate and mixtures thereof. The term “(meth)acrylate” here comprises not only the corresponding ester of acrylic acid but also the corresponding ester of methacrylic acid.

Suitable esters of vinyl alcohol and allyl alcohol with C₁-C₃₀ monocarboxylic acids are, for example, vinyl formate, vinyl acetate, vinyl propionate, vinyl butyrate, vinyl laurate, vinyl stearate, vinyl esters of Versatic acid, allyl formate, allyl acetate, allyl propionate, allyl butyrate, allyl laurate, and mixtures thereof.

Suitable vinylaromatics are styrene, 2-methylstyrene, 4-methylstyrene, 2-n-butylstyrene, 4-n-butylstyrene, 4-n-decylstyrene, especially styrene.

Suitable amides and diamides of monoethylenically unsaturated C₃-C₈ monocarboxylic and C₄-C₈ dicarboxylic acids with C₁-C₃₀ alkylamines or di-C₁-C₃₀ alkylamines, in particular with C₁-C₁₀ alkylamines or di-C₁-C₁₀ alkylamines, are, in particular, the amides of acrylic acid and of methacrylic acid with C₁-C₃₀ alkylamines or di-C₁-C₃₀ alkylamines, in particular with C₁-C₁₀ alkylamines or di-C₁-C₁₀ alkylamines, such as, for example, N-methyl(meth)acrylamide, N-ethyl(meth)acrylamide, N-propyl(meth)-acrylamide, N-(n-butyl)(meth)acrylamide, N-(tert-butyl)(meth)acrylamide, N-(n-octyl)-(meth)acrylamide, N-(1,1,3,3-tetramethylbutyl)(meth)acrylamide, N-ethylhexyl(meth)-acrylamide, N-(n-nonyl)(meth)acrylamide, N-(n-decyl)(meth)acrylamide, N-(n-undecyl)(meth)acrylamide, N-tridecyl(meth)acrylamide, N-myristyl(meth)-acrylamide, N-pentadecyl(meth)acrylamide, N-palmityl(meth)acrylamide, N-heptadecyl(meth)acrylamide, N-nonadecyl(meth)acrylamide, N-arachidyl(meth)-acrylamide, N-behenyl(meth)acrylamide, N-lignoceryl(meth)acrylamide, N-cerotyl-(meth)acrylamide, N-melissyl(meth)acrylamide, N-palmitoleyl(meth)acrylamide, N-oleyl(meth)acrylamide, N-linolyl(meth)acrylamide, N-linolenyl(meth)acrylamide, N-stearyl(meth)acrylamide, N-lauryl(meth)acrylamide, N,N-dimethyl(meth)acrylamide, N,N-diethyl(meth)acrylamide, but also the diamides and imides of maleic acid with C₁-C₃₀ alkylamines or di-C₁-C₃₀ alkylamines, in particular with C₁-C₁₀ alkylamines or di-C₁-C₁₀ alkylamines, such as, for example, N,N′-dimethylmaleamide, N,N′-diethyl-maleamide, N,N′-dipropylmaleamide, N,N′-di-(tert-butyl)maleamide, N,N′-di-(n-octyl)-maleamide, N,N′-di-(n-nonyl)maleamide, N,N′-ditridecylmaleamide, N,N′-dimyristyl-maleamide, N,N,N′,N′-tetramethylmaleamide, N,N,N′,N′-tetraethylmaleamide, and mixtures thereof. The term “(meth)acrylamide” here comprises both the corresponding amide of acrylic acid and the corresponding amide of methacrylic acid.

Suitable vinyl halides and vinylidene halides are vinyl chloride, vinylidene chloride, vinyl fluoride, vinylidene fluoride, and mixtures thereof.

The at least one monomer M1 is preferably selected from esters of monoethylenically unsaturated C₃-C₈ monocarboxylic acids, in particular the esters of acrylic acid (acrylates) and the esters of methacrylic acid (methacrylates), with C₁-C₁₀ alkanols, and vinylaromatics, more particularly from C₁-C₁₀ alkylacrylates and C₁-C₁₀ alkylmethacrylates and vinylaromatics, which may be partially substituted by C₂-C₁₀ alkenylcarbonitriles such as acrylnitrile and methacrylnitrile, and especially from methyl acrylate, ethyl acrylate, n-proply acrylate, iso-propyl acrylate, n-butyl acrylate, n-proply acrylate, iso-propyl acrylate, tert-butyl acrylate, 2-ethylhexyl acrylate, methyl methacrylate, n-butyl methacrylate, tert-butyl methacrylate, styrene, and acrylonitrile.

Corresponding to one preferred embodiment of the invention, the polymer (P) comprises in copolymerized form at least one monomer M1 and in particular at least two monomers M1 which are selected from esters of monoethylenically unsaturated C₃-C₈ monocarboxylic acids, more particularly the esters of acrylic acid and methacrylic acid, with C₁-C₃₀ alkanols, in particular with C₁-C₁₀ alkanols, and vinylaromatics. Corresponding to one particularly preferred embodiment, the polymer (P) comprises in copolymerized form at least one monomer M1.1 and at least one monomer M1.2, the at least one monomer M1.1 being selected from C₁-C₁₀ alkylacrylates and preferably from methyl acrylate, ethyl acrylate, n-proply acrylate, iso-propyl acrylate, n-butyl acrylate, n-proply acrylate, iso-propyl acrylate,tert-butyl acrylate and 2-ethylhexyl acrylate, and the at least one monomer M1.2 being selected from C₁-C₁₀ alkyl methacrylates and vinylaromatics, and preferably from methyl methacrylate, n-butyl methacrylate, tert-butyl methacrylate and styrene.

According to the invention the fraction of the monomers M1, based on the total amount of the monomers M, is in the range from 90% to 99.9% by weight, more particularly in the range from 92% to 99.8% by weight, and more preferably in the range from 93% to 99.5% by weight.

Furthermore, for a number of applications those polymers (P) are preferred in which the weight ratio of copolymerized monomers M1.1 and M1.2, i.e., the weight ratio M1.1:M1.2, is situated in the range from 25:1 to 1:20, preferably in the range from 15:1 to 1:10, and especially in the range from 5:1 to 1:3. For this purpose, in particular, polymers (P) are preferred which comprise 50% to 100% by weight and preferably 80% to 100% by weight of monomers M1.1 and also 0% to 50% by weight and preferably 0% to 20% by weight of monomers M1.2 in copolymerized form.

The monomers M2 are preferably selected from monoethylenically unsaturated monomers which have at least two hydroxyl groups attached to vicinal C atoms. These include in principle all monoethylenically unsaturated monomers which in addition to a C═C double bond, taking preferably the form of an acryloyl group (—C(O)—CH═CH₂), methacryloyl group (C(O)—C(CH₃)═CH₂), maleyl group (—C(O)—CH═CH—CO₂H), allyl group (—CH₂C(CH₃)═CH₂), methallyl group (—CH₂C(CH₃)═CH₂) or vinyl group (—CH═CH₂) attached via a heteroatom such as oxygen or nitrogen, have at least one structural element of the formula —CH(OH)—CH(OH)—. Preferred among these are those monomers in which the structural element is part of the radicals of the following formulae Z¹ or Z²:

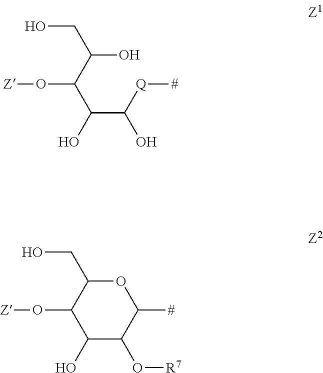

in which
Q is C(O) or CH₂,
Z′ is hydrogen or a monosaccharide or oligosaccharide radical, more particularly hydrogen or a monosaccharide radical, e.g., a glycosyl radical, and especially hydrogen, and
R⁷ is hydrogen or methyl.

In one preferred embodiment the monomers M2 are selected from monomers of the general formula I:

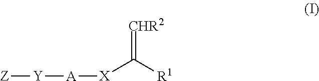

in which
R¹ is hydrogen or methyl;
R² is hydrogen or COOH;
X is O, NR³, CH₂O, CH₂NR³, C(═O)O or C(O)NR⁴, the carbon atom in the 4 last mentioned radicals being attached to the carbon atom which carries R¹, where R³ is hydrogen, C₁-C₄ alkyl or a group Z—Y-A, and R⁴ is hydrogen or C₁-C₄ alkyl;
A is C₂-C₂₀ alkylene or a group —R⁵—O—[—R⁵—O—]ₓ—C₂—C₂₀ alkylene, where R⁵ is CH₂CH₂ or C₃H₆ and x is an integer from 0 to 20;
Y is a chemical bond, O or NR⁶, where R⁶ is hydrogen or C₁-C₄ alkyl; or
A-Y is a chemical bond or CH₂; and
Z is a radical of the formulae Z¹ or Z² as defined above.

In formula I, X, A, and Y, alone or, in particular, together, have one of the following definitions:
X is O, NH, N—CH₃, CH₂O, CH₂NH, CH₂NCH₃, C(═O)O, C(O)NH, C(O)NCH₃ or C(O)N—(CH₂)ₙ—NH—Z, where Z has one of the above-stated definitions and n is 2, 3 or 4, and where the carbon atom in the 7 last-mentioned radicals is attached to the carbon atom which carries R¹;
A is C₂-C₆ alkylene, more particularly (CH₂)ₘ, in which m is 2, 3 or 4;
Y is a chemical bond, O or NR^{6′}, in which R^{6′} is hydrogen or methyl; or
A-Y is a chemical bond or CH₂.

The monoethylenically unsaturated compounds of the formula I that are preferred as monomer M2 are known or can be prepared in analogy to the methods described by Park et al., in J. Biomed Mater. Res. A, 2004, 71, 497-507 or J. Biotechnol. 2004, 107, 151-160, or by the methods described in U.S. Pat. No. 2,084,626, DE 1 048 574, PCT/EP 2010/054208, PCT/EP 2010/054211, and WO 90/10023.

Examples of particularly preferred monomers M2 are N-allylgluconamide, N-allylaminoglucose, 2-(N-gluconylamino)ethyl vinyl ether, 3-(N-gluconylamino)propyl vinyl ether, N-[2-(gluconylamino)ethyl]maleamide, N-[3-(gluconylamino)propyl]-maleamide, N-[2-(gluconylamino)ethyl-N′-methyl]maleamide, N-[3-(gluconylamino)-propyl-N′-methylmaleamide, N,N-bis[2-(gluconylamino)ethyl]maleamide, N,N-bis[3-(gluconylamino)propyl]maleamide, N-[2-(acrylamido)ethyl]gluconamide, N-[2-(methacrylamido)ethyl]gluconamide, N-[3-(acrylamido)propyl]gluconamide, N-[3-(methacrylamido)propyl]gluconamide, N-methylglucaminoacrylamide, N-methyl-glucaminomethacrylamide, N-methylaminoglucoseacrylamide, N-methylaminoglucose-methacrylamide, N-maltoyl-N-methylacrylamide, N-maltoyl-N-methylmethacrylamide, N-allyllactobionamide, N-allylmaltobionamide, N-allylaminomaltose, N-allylamino-oligomaltose, glycidyl methacrylate, glycidyl acrylate, and 1-methacrylamido-2-D-gluconylaminoethane.

In one particularly preferred embodiment the monomers M2 are selected from monomers of the general formula Ia:

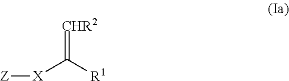

in which R¹, R², X, and Z are as defined above and in which R¹ in particular is hydrogen, and in which X preferably has one of the following definitions:
X is O, NH, N—CH₃, CH₂O, CH₂NH, CH₂NCH₃, C(═O)O, C(O)NH or C(O)NCH₃, where the carbon atom in the 6 last-mentioned radicals is attached to the carbon atom which carries R¹.

Monomers of the formula Ia are, for example, N-allylgluconamide, N-allylaminoglucose, N-methylglucaminoacrylamide, N-methylglucaminomethacrylamide, N-methylamino-glucoseacrylamide, N-methylaminoglucosemethacrylamide, N-maltoyl-N-methyl-acrylamide, N-maltoyl-N-methylmethacrylamide, N-allyllactobionamide, N-allylmalto-bionamide, N-allylaminomaltose, N-allylaminooligomaltose.

In a likewise preferred embodiment the monomers M2 are selected from monomers of the general formula Ib:

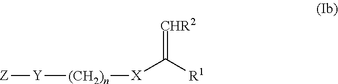

in which n is 2, 3 or 4 and in which R¹, R², X, Y, and Z are as defined above, in which R¹ in particular is hydrogen, and in which X and Y, alone or, in particular, together, have one of the following definitions:
X is O, NH, N—CH₃, CH₂O, CH₂NH, CH₂NCH₃, C(═O)O, C(O)NH, C(O)NCH₃ or C(O)N—(CH₂)ₙ—NH—Z, where Z has one of the above-stated definitions and n is 2, 3 or 4, and where the carbon atom in the 7 last-mentioned radicals is attached to the carbon atom which carries R¹;
Y is a chemical bond, O or NR^{6′}, in which R^{6′} is hydrogen or methyl.

Examples of particularly preferred monomers of formula Ib are 2-(N-gluconyl-amino)ethyl vinyl ether, 3-(N-gluconylamino)propyl vinyl ether, N[-2-(gluconylamino)-ethyl]maleamide, N-[3-(gluconylamino)propyl]maleamide, N-[2-(gluconylamino)ethyl-N′-methyl]maleamide, N-[3-(gluconylamino)propyl-N′-methylmaleamide, N,N-bis[2-(gluconylamino)ethyl]maleamide, N,N-bis[3-(gluconylamino)propyl]maleamide, N-[2-(acrylamido)ethyl]gluconamide, N-[2-(methacrylamido)ethyl]gluconamide, N-[3-(acrylamido)propyl]gluconamide, N-[3-(methacrylamido)propyl]gluconamide, and 1-methacrylamido-2-D-gluconylaminoethane.

The monomers M2 additionally include in principle all monoethylenically unsaturated monomers which, in addition to a C═C double bond, which is present preferably in the form of an acryloyl group (—C(O)—CH═CH₂), methacryloyl group (C(O)—C(CH₃)═CH₂), maleyl group (—C(O)—CH═CH—CO₂H), allyl group (—CH₂C(CH₃)═CH₂), methallyl group (—CH₂C(CH₃)═CH₂) or vinyl group (—CH═CH₂) attached via a heteroatom such as oxygen or nitrogen, have at least one functional group which on hydrolysis is converted into structural element of the formula —CH(OH)—CH(OH)—. Examples of functional groups of this kind are

ethylene carbonate groups:

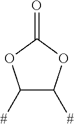

oxirane groups:

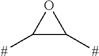

and 1,3-dioxolane groups

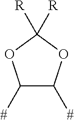

(R independently at each occurrence is, for example, hydrogen or methyl).

Examples of monomers M2 of this kind are glycidyl acrylate (acrylic acid oxiranylmethyl ester), glycidyl methacrylate (methacrylic acid oxiranylmethyl ester), acrylic acid 1,3-dioxolan-4-ylmethyl ester, methacrylic acid 1,3-dioxolan-4-ylmethyl ester, acrylic acid 2,2-dimethyl-1,3-dioxolan-4-ylmethyl ester, methacrylic acid 2,2-dimethyl-1,3-dioxolan-4-ylmethyl ester, acrylic acid 2-oxo-1,3-dioxolan-4-ylmethyl ester, methacrylic acid 2-oxo-1,3-dioxolan-4-ylmethyl ester.

Preferred water-insoluble polymers (P) are those in which the fraction of the monomers M2 is situated in the range from 0.2% to 7% by weight, and more particularly in the range from 0.5% to 5% by weight, based in each case on the total weight of the monomers M used for the polymerization.

The monomers M may, further to the monomers M1 and M2, comprise one or more monomers M3 which are selected from monoethylenically unsaturated monomers having at least one carboxylate or carboxamido group.

The fraction of the monomers M3, based on the total amount of the monomers M, will generally not exceed 9% by weight and more particularly 3% by weight and is situated typically in the range from 0.05% to 9% by weight, more particularly in the range from 0.1% to 3% by weight, and especially in the range from 0.2% to 2% by weight. Where the polymers P comprise in copolymerized form one or more monomers M3, the total amount of the monomers M2 and M3 will not exceed generally 10% by weight, more particularly 8% by weight, and especially 7% by weight, and the total amount is preferably in the range from 0.15% to 10% by weight, more particularly in the range from 0.3% to 8% by weight, and especially in the range from 0.6% to 7% by weight, based on the total amount of the monomers M. Accordingly, then, the total amount of the monomers M1 is in the range from 90% to 99.85% by weight, more particularly in the range from 92% to 99.7% by weight, and especially in the range from 93% to 99.3% by weight, based on the total amount of the monomers M.

Monomers M3 are preferably selected from monoethylenically unsaturated C₃-C₈ monocarboxylic acids such as acrylic acid and methacrylic acid, monoethylenically unsaturated C₄-C₈ dicarboxylic acids such as maleic acid, fumaric acid, and itaconic acid, and the primary amides of monoethylenically unsaturated C₃-C₈ monocarboxylic acids, such as acrylamide and methacrylamide.

Further to the monomers M1, M2, and M3, the monomers M may comprise one or more monomers M4, which are selected from the hydroxy-C₂-C₄ alkyl esters of monoethylenically unsaturated C₃-C₈ monocarboxylic acids, monoesters of monoethylenically unsaturated C₃-C₈ monocarboxylic or C₄-C₈ dicarboxylic acids with polyoxy-C₂-C₄ alkylene ethers, and monoethylenically unsaturated monomers having at least one urea group.

Hydroxy-C₂-C₄ alkyl esters of monoethylenically unsaturated C₃-C₈ monocarboxylic acids that are suitable as M4 are, for example, the hydroxy-C₂-C₄ alkyl esters of acrylic acid and of methacrylic acid, such as 2-hydroxyethyl acrylate, 2-hydroxyethyl methacrylate, 2-hydroxyethyl ethacrylate, 2-hydroxypropyl acrylate, 2-hydroxypropyl methacrylate, 3-hydroxypropyl acrylate, 3-hydroxypropyl methacrylate, 3-hydroxybutyl acrylate, 3-hydroxybutyl methacrylate, 4-hydroxybutyl acrylate, 4-hydroxybutyl methacrylate, and mixtures thereof.

Suitable monomers M4 having at least one urea group are, for example, N-vinylurea, N-(2-acryloyloxyethyl)imidazolidin-2-one and N-(2-methacryloyloxyethyl)imidazolidin-2-one (2-ureidomethacrylate, UMA).

Suitable monomers M4 from the group of the monoesters of monoethylenically unsaturated C₃-C₈ monocarboxylic or C₄-C₈ dicarboxylic acids with polyoxy-C₂-C₄ alkylene ethers are, for example, the monoesters of monoethylenically unsaturated C₃-C₈ monocarboxylic acids, more particularly of acrylic acid and of methacrylic acid, with poly-C₂-C₄ alkylene ethers of the general formula (A)

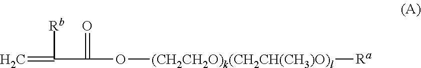

in which

the sequence of the alkylene oxide units is arbitrary,

k and I independently of one another are each an integer in the range from 0 to 100, in particular in the range from 0 to 50, the sum of k and I being at least 3, more particularly 4, e.g., 3 to 200, and more particularly 4 to 100,

R^{a} is hydrogen, C₁-C₃₀ alkyl, C₅-C₈ cycloalkyl or C₆-C₁₄ aryl, and

R^{b} is hydrogen or C₁-C₈ alkyl, more particularly hydrogen or methyl.

Preferably k is an integer from 3 to 50, more particularly 4 to 30. Preferably I is an integer from 0 to 30, more particularly 0 to 20. More preferably I is 0. Preferably the sum of k and I is situated in the range from 3 to 50 and more particularly in the range from 4 to 40.

R^{a} in the formula (A) is preferably hydrogen, C₁-C₂₀ alkyl, e.g., methyl, ethyl, n-propyl, isopropyl, n-butyl or sec-butyl, n-pentyl, n-hexyl, octyl, 2-ethylhexyl, decyl, lauryl, palmityl or stearyl. R^{a} is more preferably hydrogen or C₁-C₄ alkyl.

R^{b} is preferably hydrogen or methyl.

The at least one monomer M4 is preferably selected from hydroxy-C₂-C₄ alkyl esters of monoethylenically unsaturated C₃-C₈ monocarboxylic acids, 2-ureidomethacrylate, and poly-C₂-C₄ alkylene ethers of the general formula (A′)

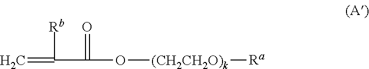

in which

k is an integer from 4 to 40, R^{a} is hydrogen or C₁-C₄ alkyl, and R^{b} is hydrogen or methyl.

Preferred polymers (P) are obtainable by means of a polymerization of the monomers M in which the fraction of the monomers M4 is situated in the range from 0% to 9% by weight, more particularly in the range from 0% to 5% by weight.

Where the polymers (P) comprise in copolymerized form one or more monomers M3 or M4, the total amount of the monomers M2, M3 and/or M4 will not exceed generally 10% by weight, more particularly 8% by weight, and especially 7% by weight, and the total amount is preferably in the range from 0.15% to 10% by weight, more particularly in the range from 0.3% to 8% by weight, and especially in the range from 0.6% to 7% by weight, based on the total amount of monomers M. In that case, accordingly, the total amount of monomers M1 is situated in the range from 90% to 99.85% by weight, more particularly in the range from 92% to 99.7% by weight, and especially in the range from 93% to 99.3% by weight, based on the total amount of the monomers M.

Besides the aforementioned monoethylenically unsaturated monomers, the polymer (P) may also comprise in copolymerized form small amounts of polyethylenically unsaturated monomers (monomers M5), which in the preparation of the polymer (P) lead to internal crosslinking. The fraction of such monomers, however, will not exceed generally 1% by weight, more particularly 0.5% by weight, and especially 0.1% by weight, based on the total amount of the monomers M that constitute the polymer. Examples of polyethylenically unsaturated monomers are diesters and triesters of ethylenically unsaturated carboxylic acids, more particularly the bisacrylates of diols and triols and the trisacrylates of triols and tetraols, e.g., the bisacrylates and the bismethacrylates of ethylene glycol, diethylene glycol, triethylene glycol, neopentyl glycol or polyethylene glycols, vinyl and allyl esters of saturated or unsaturated dicarboxylic acids, vinyl and allyl esters of monoethylenically unsaturated monocarboxylic acids, and also N,N-diallylamines with hydrogen or an alkyl group as further substituents on the nitrogen, especially N,N-diallylamine and N,N-diallyl-N-methylamine. Preferably, however, the polymer (P) does not comprise any polyethylenically unsaturated monomers.

Further suitable monomers M are, for example, monoethylenically unsaturated phosphonic and sulfonic acids, e.g., vinylphosphonic acid and allylphosphonic acid, vinylsulfonic acid, allylsulfonic acid, sulfoethyl acrylate, sulfoethyl methacrylate, sulfopropyl acrylate, sulfopropyl methacrylate, 2-hydroxy-3-acryloyloxypropylsulfonic acid, 2-hydroxy-3-methacryloyloxypropylsulfonic acid, styrenesulfonic acids, and 2-acrylamido-2-methylpropanesulfonic acid, styrenesulfonic acids and their derivatives, such as styrene-4-sulfonic acid and styrene-3-sulfonic acid, for instance, and also the salts, especially the alkaline earth metal salts or alkali metal salts, of the aforementioned acids, such as sodium styrene-3-sulfonate and sodium styrene-4-sulfonate, for instance, and also monoesters and diesters of hydroxy-C₂-C₄ alkyl acrylates or methacrylates such as hydroxyethyl acrylate, hydroxypropyl acrylate, hydroxybutyl acrylate, hydroxyethyl methacrylate, hydroxypropyl methacrylate or hydroxybutyl methacrylate, with phosphoric acid, and the salts of these phosphoric monoesters and diesters, more particularly the alkali metal salts and alkaline earth metal salts.

The fraction of monomers M, which are phosphonic acids, sulfonic acids, phosphoric esters or salts thereof, based on the total amount of the monomers M constituting the polymer (P), is situated in the range from 0% to 2% by weight and is preferably ≦0.1% by weight.

In one preferred embodiment of the present invention the polymer (P), based on the total amount of the monomers M constituting the polymer (P), is composed of at least 98% by weight, more particularly at least 99.5% by weight, and especially at least 99.9% by weight, or 100% by weight, of monoethylenically unsaturated monomers M, the monomers M in this case preferably comprising the following monomers:
90% to 99.9% by weight, or 90% to 99.85% by weight, preferably 92% to 99.8% by weight, or 92% to 99.7% by weight and more particularly 93% to 99.5% by weight or 93% to 99.3% by weight of monomers M1 which are selected from neutral, monoethylenically unsaturated monomers of low water-solubility, and more particularly from esters of α,β-ethylenically unsaturated carboxylic acids with C₁-C₃₀ alkanols and vinylaromatics;
0.1% to 10% by weight, preferably 0.2% to 7% by weight, more particularly 0.5% to 5% by weight, of monomers M2 which among monoethylenically unsaturated monomers have with at least two hydroxyl groups bound to vicinal C atoms;
   and also, optionally:
0% to 9% by weight, e.g. 0.05% to 9% by weight, more particularly 0.1% to 3% by weight, and especially 0.2% to 2% by weight of monomers M3, which are selected from monoethylenically unsaturated monomers having at least one carboxylate or carboxamido group;
   and/or:
0% to 9% by weight, more particularly 0% to 5% by weight, and especially 0% to 3% by weight of monomers M4, which are selected from hydroxy-C₂-C₄ alkyl esters of monoethylenically unsaturated monocarboxylic acids, monoesters of monoethylenically unsaturated carboxylic acids with polyoxy-C₂-C₄ alkylene ethers, and monoethylenically unsaturated monomers having at least one urea group.

The polymers (P) preferably have a weight-average molecular weight M_{w} in the range from about 10 000 to 20 000 000, and preferably in the range from about 50 000 to 10 000 000. The molar mass may be determined by gel permeation chromatography with a standard, such as polymethyl methacrylate.

The glass transition temperature T_{g} of the polymer (P) is dependent on the desired application and is situated generally in the range from −60° C. to 60° C., preferably in the range from −50° C. to 50° C., and more preferably in the range from −40° C. to 50° C. By the glass transition temperature is meant the midpoint temperature according to ASTM 3418/82, as may be determined by means of differential scanning calorimetry (DSC). The glass transition temperature of a polymer may also be determined by dynamic-mechanical analysis (DMTA) in accordance with the method indicated in connection with the examples. The glass transition temperature may be set through appropriate selection of the monomers M1.

In addition to the polymer (P), the aqueous binder compositions and the aqueous polymer dispersions, respectively, and correspondingly also the powders obtainable therefrom, typically further comprise at least one surface-active substance for the purpose of stabilizing the polymer particles of the polymer (P). These substances include ionic and nonionic emulsifiers and also ionic and nonionic protective colloids or stabilizers. Emulsifiers, in contrast to protective colloids, are surface-active substances whose molecular weight (numerical average) is situated typically below 2000 g/mol and especially below 1500 g/mol. Protective colloids in turn are typically water-soluble polymers having a number-average molecular weight of more than 2000 g/mol, e.g., in the range from 2000 to 100 000 g/mol, and more particularly in the range from 5000 to 50 000 g/mol. It is of course possible to use protective colloids and emulsifiers in a mixture.

The amount of surface-active substance is situated typically in the range from 0.1% to 10% by weight, preferably 0.2% to 5% by weight, based on 100% by weight of polymer, or on 100% by weight of the monomers M that constitute the polymer.

The aqueous binder compositions and polymer dispersions according to the invention preferably comprise exclusively emulsifiers as surface-active substance. In particular it has been found appropriate for the polymer dispersion to comprise a combination of at least one anionic and at least one nonionic emulsifier as surface-active substances. The emulsifiers are in general not polymerizable—that is, they contain no ethylenically unsaturated groups that are polymerizable in a free-radical polymerization. Part or the entirety of the emulsifiers, however, may be polymerizable. Polymerizable emulsifiers of this kind comprise ethylenically unsaturated groups and are either nonionic or anionic emulsifiers. Polymerizable nonionic emulsifiers are preferably selected from C₂-C₃ alkoxylates of alkenols, more particularly of prop-2-en-1-ol, and monoesters of monoethylenically unsaturated monocarboxylic or dicarboxylic acids with poly-C₂-C₃ alkylene ethers, the degree of alkoxylation being usually 3 to 100 in each case. Polymerizable anionic emulsifiers are preferably selected from the corresponding sulfuric and phosphoric monoesters of the aforementioned nonionic polymerizable emulsifiers.

The nonpolymerizable anionic emulsifiers typically include aliphatic carboxylic acids having in general at least 10 C atoms, and also their salts, more particularly their ammonium salts and alkali metal salts, aliphatic, araliphatic, and aromatic sulfonic acids having generally at least 6 C atoms, and also their salts, more particularly their ammonium salts and alkali metal salts, sulfuric monoesters with ethoxylated alkanols and alkylphenols, and also their salts, more particularly their ammonium salts and alkali metal salts, and also alkyl, aralkyl, and aryl phosphates, including phosphoric monoesters of alkanols and alkylphenols.

Examples of suitable anionic emulsifiers are as follows: alkali metal salts and ammonium salts of dialkyl esters of sulfosuccinic acid, alkali metal salts and ammonium salts of alkyl sulfates (alkyl radical: C₈ to C₁₈), alkali metal salts and ammonium salts of sulfuric monoesters with ethoxylated alkanols (EO degree: 4 to 30, alkyl radical: C₈ to C₁₈), alkali metal salts and ammonium salts of sulfuric monoesters with ethoxylated alkyl phenols (EO degree: 3 to 50, alkyl radical: C₄ to C₁₆), alkali metal salts and ammonium salts of alkylsulfonic acids (alkyl radical: C₈ to C₁₈), and of alkylarylsulfonic acids (alkyl radical: C₄ to C₁₈). Examples of suitable anionic emulsifiers are also the below-specified compounds of the general formula

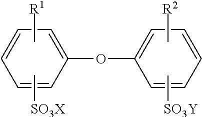

in which R¹ and R² are hydrogen or C₄ to C₁₄ alkyl and are not simultaneously hydrogen, and X and Y may be alkali metal ions and/or ammonium ions. Preferably R¹ and R² are hydrogen or linear or branched alkyl radicals having 6 to 18 C atoms and more particularly having 6, 12 and 16 C atoms, R¹ and R² not both simultaneously being hydrogen. X and Y are preferably sodium, potassium or ammonium ions, with sodium being particularly preferred. Particularly advantageous compounds are those in which X and Y are sodium, R¹ is a branched alkyl radical having 12 C atoms, and R² is hydrogen or has one of the non-hydrogen definitions stated for R¹. Frequently, technical mixtures are used which contain a fraction of 50% to 90% by weight of the monoalkylated product, for example, Dowfax®2A1 (trade mark of the Dow Chemical Company).

Suitable nonionic emulsifiers are typically ethoxylated alkanols having 8 to 36 C atoms in the alkyl radical, ethoxylated mono-, di-, and trialkylphenols having typically 4 to 12 C atoms in the alkyl radicals, the ethoxylated alkanols and alkylphenols typically having a degree of ethoxylation in the range from 3 to 50.

Further suitable emulsifiers are found, for example, in Houben-Weyl, Methoden der organischen Chemie, Volume 14/1, Makromolekulare Stoffe [Macromolecular compounds], Georg Thieme Verlag, Stuttgart, 1961, pp. 192 to 208.

In the aqueous binder compositions according to the invention and in the aqueous polymer dispersions according to the invention, the polymer (P) is present as a heterogeneous phase in the form of finely divided particles which are dispersed or suspended in a homogeneous aqueous phase. The homogeneous aqueous phase may, besides water and also the auxiliaries that are typically used for the preparation, such as surface-active substances, acids, bases and decomposition products from the polymerization reaction, further comprise small amounts of water-miscible organic solvents. The fraction of the last-mentioned components will typically not exceed 1% by weight, based on the total weight of the dispersion.

The aqueous polymer dispersion of the polymer (P) may constitute the direct product of a free-radical aqueous emulsion polymerization of the monomer M, or may constitute a secondary dispersion, i.e. the polymer (P) is suspended or dispersed in water following the production thereof. In this context, the free-radical aqueous emulsion polymerization may also be carried out as what is called a miniemulsion polymerization; that is, the monomers for polymerization are used in the form of an aqueous miniemulsion in which the monomer droplets have very small diameters (volume-average droplet diameter of the monomer emulsion <1 μm, more particularly <0.6 μm). A secondary dispersion is an aqueous polymer dispersion whose polymer is first prepared in a solution polymerization or in some other way and is then dispersed or emulsified in an aqueous medium, optionally with removal of organic solvent from the solution polymerization. With an eye to the applications, polymer dispersions are preferred that have been prepared by means of free-radical aqueous emulsion polymerization. Preference is given in this context to polymer dispersions in which the dispersed polymer particles have an average particle diameter, determined by light scattering, in the range from 0.03 to 1.5 μm and more particularly in the range from 0.05 to 1 μm. The average particle diameter is understood to be the average value of the cumulant analysis (mean of fits) as determined by quasielastic light scattering (QELS) on diluted polymer dispersions (0.001% to 1% by weight, 22° C.).

For the polymer dispersions used in accordance with the invention it has proven advantageous to employ the below-described process of a free-radical aqueous emulsion polymerization of the monomers M that constitute the polymer (P). With this process a free-radical aqueous emulsion polymerization of the ethylenically unsaturated monomers M is carried out in a manner known per se and preferably according to a monomer feed process, in which, preferably, at least one particulate seed polymer is used, which is in particular introduced in the initial charge in the polymerization reactor. “Introduce in the initial charge” in this context means that the seed polymer either is added before the beginning of the polymerization or is formed in the polymerization reactor before the actual emulsion polymerization, by means of emulsion polymerization in situ.

A monomer feed process means, here and below, that at least 90% and more particularly at least 95% of the monomers to be polymerized are charged under polymerization conditions to a polymerization reactor. Preferably, the polymerization reactor already contains a first particulate seed polymer, typically in the form of an aqueous dispersion of the seed polymer.

The skilled worker understands the term “seed polymer” to refer to a finely divided polymer in the form of an aqueous polymer dispersion. The weight-average particle size of the seed polymers used in the process of the invention (weight average, d₅₀) is typically below 200 nm, frequently in the range from 10 to 150 nm, and more particularly in the range from 20 to 120 nm. The monomer composition of the seed polymers is of minor importance. Suitability is possessed both by seed polymers which are constructed predominantly of vinylaromatic monomers, and more particularly of styrene (so-called styrene seed), and by seed polymers which are composed predominantly of C₁-C₁₀ alkylacrylates and/or C₁-C₁₀ alkylmethacrylates, such as of a mixture of butyl acrylate and methyl methacrylate, for example. Besides these principal monomers, which account typically for at least 80% and more particularly at least 90% by weight of the seed polymer, the seed polymers may also comprise, in copolymerized form, different monomers, more particularly those having an increased water-solubility, examples being monomers having at least one acid function and/or neutral monomers with increased water-solubility and/or monomers having two or more ethylenically unsaturated double bonds (monomers M5). The fraction of such monomers will generally not exceed 20% and more particularly 10% by weight, and is situated, where present, typically in the range from 0.1% to 10% by weight, based on the total amount of the monomers that constitute the seed polymer.

The free-radical aqueous emulsion polymerization is performed typically in the presence of surface-active substances as described above. In the process of the invention it is preferred to use exclusively emulsifiers. More particularly it has been found appropriate to use a combination of at least one anionic and at least one nonionic emulsifier as surface-active substance.

Typically the surface-active substances are used in amounts of 0.1% to 10% by weight, more particularly in amounts of 0.2% to 5% by weight, based on the weight of the monomers M to be polymerized.

The initiators used for the free-radical emulsion polymerization are typically water-soluble substances that form free radicals.

Water-soluble initiators for the emulsion polymerization are organic or inorganic peroxide compounds, i.e., compounds having at least one peroxide or hydroperoxide group, examples being ammonium salts and alkali metal salts of peroxodisulfuric acid, e.g., sodium peroxodisulfate, or hydrogen peroxide or organic peroxides, e.g., tert-butyl hydroperoxide.

Also suitable are what are called reduction-oxidation (redox) initiator systems. The redox initiator systems are composed of at least one, usually inorganic reducing agent and one organic or inorganic oxidizing agent. The oxidizing component comprises, for example, the peroxide compounds already stated above. The reducing components comprise, for example, alkali metal salts of sulfurous acid, such as sodium sulfite, sodium hydrogen sulfite, alkali metal salts of disulfurous acid such as sodium disulfite, bisulfite addition compounds with aliphatic aldehydes and ketones, such as acetone bisulfite, or reducing agents such as hydroxymethanesulfinic acid and its salts, or ascorbic acid. The redox initiator systems can be used in combination with soluble metal compounds whose metallic component is able to exist in a plurality of valence states. Typical redox initiator systems are exemplified by ascorbic acid/iron(II) sulfate/sodium peroxodisulfate, tert-butyl hydroperoxide/sodium disulfite, and tert-butyl hydroperoxide/Na hydroxymethanesulfinate. The individual components, the reducing component, for example, may also be mixtures, an example being a mixture of the sodium salt of hydroxymethanesulfinic acid with sodium disulfite.

The stated initiators are used mostly in the form of aqueous solutions, the lower concentration being determined by the amount of water that is acceptable in the dispersion, and the upper concentration by the solubility of the respective compound in water. Generally speaking, the concentration is 0.1% to 30%, preferably 0.5% to 20%, more preferably 1.0% to 10%, by weight, based on the solution.

The amount of initiators is generally 0.1% to 10% by weight, preferably 0.2% to 5% by weight, based on the monomers to be polymerized. It is also possible for two or more different initiators to be used for the emulsion polymerization.

In the polymerization it is possible to use regulators, in amounts of 0% to 1% by weight, for example, based on the monomers M to be polymerized. By this means the molar mass of the polymer is reduced. Suitability is possessed, for example, by compounds having a thiol group such as tert-butyl mercaptan, mercaptoethanol, thioglycolic acid, ethyl thioglycolate, mercaptopropyltrimethoxysilane, and tert-dodecyl mercaptan. If appropriate it is of advantage to add the regulator in the course of the polymerization over a relatively long period, parallel, for example, with the addition of the monomers M. The addition may then be made at a continuous feed rate or with an increasing or decreasing feed rate.

The process of the invention is preferably performed as a feed process, i.e., at least 90% of the monomers M to be polymerized are added to the polymerization reactor in the course of the polymerization under polymerization conditions. The addition may be made continuously or in stages. In the course of the polymerization the monomer composition may be altered once, a number of times or else continuously (gradient procedure).

A preferred procedure in the process of the invention is to introduce in the initial charge an externally produced seed polymer in the form of an aqueous dispersion, together if appropriate with water. Alternatively the seed polymer can be prepared beforehand in situ by emulsion polymerization, preferably using a small portion of the monomers M. Following initial introduction or synthesis of the seed polymer, the initial charge is heated to polymerization temperature, if this has not already taken place, and then a portion of the polymerization initiator is added, e.g., 1% to 20% and more particularly 5% to 15% by weight, based on the total amount of the initiator. An alternative procedure is first to add the portion of the polymerization initiator and then to carry out heating to polymerization temperature. At this point the polymerization reactor preferably receives less than 5% by weight of the monomers M to be polymerized. Subsequently the addition takes place of the monomers to be polymerized to the polymerization reactor under polymerization conditions. The addition is performed typically over a relatively long period of generally at least 30 minutes, 30 minutes to 10 hours for example, more particularly over a period of 1 h to 6 h. As already outlined, the addition may be performed with a constant, increasing or decreasing rate of addition. In a first preferred embodiment the addition is made at the beginning of the polymerization with increasing feed rate. In another, likewise preferred embodiment of the process of the invention, the addition is made at a constant rate of addition. The monomers can be added as they are. Preferably the monomers are added in the form of an aqueous monomer emulsion which typically comprises at least part, preferably at least 70% by weight, of the surface-active substances used in the emulsion polymerization. This monomer emulsion typically has a monomer content in the range from 60% to 85% by weight and more particularly in the range from 65% to 80% by weight. It is possible in principle to add the monomers or the monomer emulsion to the polymerization reactor by way of two or more feeds, in which case the monomer composition of the individual feeds may differ. In general, however, it is sufficient to add the monomers as a mixture via one feed to the polymerization reactor. Where the monomers are added in the form of an aqueous emulsion to the polymerization reactor, it can be of advantage to emulsify the monomers afresh directly before they are added and at the rate at which they are added in the polymerization reactor, by a continuous process, for example. The monomer emulsion can also be first prepared and then introduced at the desired rate of addition into the polymerization reactor.

Typically, parallel to the addition of monomer, at least a portion or the entirety of the polymerization initiator is added. At least 80% of the polymerization initiator needed for the emulsion polymerization is typically added, more particularly 85% to 95% of the polymerization initiator, to the polymerization reactor in the course of the polymerization reaction. The polymerization initiator may be added with a constant rate of addition or with a changing rate of addition—for example, a decreasing or increasing rate.

Polymerization temperature and polymerization pressure are of minor importance. The emulsion polymerization takes place typically at temperatures in the range from 30 to 130, preferably in the range from 50 to 100° C. The polymerization pressure is situated customarily in the region of atmospheric pressure, i.e., at ambient pressure, but may also be slightly above or below, in the range, for example, of 800 to 1500 mbar.

The polymerization medium may be composed either just of water or of mixtures of water and water-miscible liquids such as methanol. It is preferred to use just water.

In general it is advisable, after the end of the actual polymerization reaction, i.e., after the end of the addition of the monomers to be polymerized, or after a conversion of the monomers present in the polymerization reactor of at least 95%, to carry out a chemical and/or physical deodorization for the purpose of removing unpolymerized monomers. In general at least one chemical deodorization will be performed. A chemical deodorization is a postpolymerization phase which is initiated by adding at least one further polymerization initiator, more particularly one of the aforementioned redox initiator systems. Processes for doing this are known, from DE-A-4435422, DE-A-4435423, and DE-A-4419518, for example. The reduction in residual monomers can also be accomplished by combined measures of a chemical and physical deodorization, in which case the physical deodorization is preferably carried out after the chemical deodorization. The resulting polymer dispersions comprise preferably less than 1500 ppm, more particularly less than 1000 ppm, and more preferably less than 500 ppm of volatile organic components, TVOC. By TVOC (total volatile organic compounds) are meant all organic compounds having a boiling point of not more than 250° C. at 1 bar. The determination of the residual-volatile content is made typically in accordance with DIN 55649.

It has additionally proven advantageous if the aqueous polymer dispersion, after it has been prepared, is stabilized by addition of an anionic surface-active substance.

Preferred for this purpose are the dialkyl esters of sulfosuccinic acid or their salts, more particularly the sodium salts, especially the dialkyl esters of sulfosuccinic acid having 6 to 12 C atoms per alkyl radical. Typically the aqueous polymer dispersion is admixed, following the emulsion polymerization, with 0.05% to 2% and more particularly with 0.1% to 1% by weight of an anionic surface-active substance of this kind.

In general the aqueous polymer dispersion will also be stabilized with one or more biocides (preservatives) to counter infestation by microorganisms. These biocides include, for example, alkyl esters of para-hydroxybenzoic acid, sodium benzoate, 2-bromo-2-nitropropane-1,3-diol, ortho-phenylphenol, dichlorophen, benzyl alcohol hemiformal, pentachlorophenol, 2,4-dichlorobenzyl alcohol and also, in particular, substituted isothiazolones such as, for example, C₁-C₁₀ alkylisothiazolinones, 5-chloro-2-methyl-4-isothiazolinone, and benzoisothiazolinones, examples being the products sold under the names Proxel® from Avecia (or Arch) or Acticide® from Thor Chemie. Preservatives are used typically in amounts from 0.01 to 10 grams per liter of the polymer dispersion.

The solids content of the aqueous polymer dispersions is typically from 30% to 80% by weight, preferably 40% to 75% by weight, and especially from 45% to 70% by weight.

The polymer particles that are present in the polymer dispersions generally have an average particle diameter, determined by light scattering (see above), of 0.03 to 1.5 μm, frequently of 0.05 to 1 μm, preferably of 0.06 to 0.8 μm, and more particularly of 0.07 to 0.6 μm. The polymer particles may have either a monomodal particle size distribution, in other words a Gaussian distribution with only one maximum, or may have a polymodal distribution with at least two pronounced maxima, which differ generally by at least 0.05 μm.

For preparing the polymer dispersions with a polymodal distribution it is possible to draw on corresponding processes known from the prior art. For example, the afore-described process of a free-radical aqueous emulsion polymerization can be modified by adding a relatively large amount of emulsifier in the course of the polymerization, after some of the monomers have already undergone polymerization, and this initiates the formation of a new particle generation. One such process is known from EP 8775, for example. An alternative procedure is, at the beginning of the free-radical aqueous emulsion polymerization, first to introduce one particulate seed polymer 1, and then, in the course of the polymerization, to add at least one further seed polymer 2 in the form of an aqueous dispersion.

The above-described aqueous polymer dispersions of the polymer (P) are especially suitable as a binder component in the binder compositions of the invention.

As well as a polymer (P) in the form of an aqueous dispersion or a powder, the binder composition of the invention further comprises boric acid and/or at least one salt of boric acid, as explained above.

Salts of boric acid that are preferred in the context of this invention are salts of monoboric acid (ortho-boric acid) and of oligomeric boric acid (boric acid condensation products—metaboric acid) having up to 20 boron atoms, and the salts thereof, such as, for example, the salts of diboric acid, triboric acid, tetraboric acid, pentaboric acid, hexaboric acid, octaboric acid, decaboric acid or of dodecaboric acid including the hydrates thereof. Preference is given to the alkali metal salts, more particularly the sodium salts. Equally preferred are the ammonium salts, alkylammonium salts, and hydroxyalkylammonium salts, as defined above, the alkyl radicals in the alkylammonium salts and in the hydroxyalkylammonium salts preferably having in each case not more than 8 and more particularly not more than 4 C atoms. Preferred alkylammonium salts and hydroxyalkylammonium salts are those containing in total not more than 10 and especially not more than 8 C atoms. Examples of salts of boric acid are more particularly Na₃BO₃, Na₂HBO₃, Na₄B₂O₅, Na₃B₃O₆, boracite (Mg₃[Cl|BO₃|B₆O₁₀]), borax (Na₂[B₄O₅(OH)₄].8 H₂O=disodium tetraborate decahydrate), potassium pentaborate tetrahydrate, and disodium octaborate tetrahydrate. In the aqueous binder compositions of the invention, boric acid and/or its salts are present in dissolved form, it being possible for monomeric and oligomeric boric acid and/or salts thereof to be present alongside one another, and for the fraction of monomeric and oligomeric boric acid to be guided by the pH and/or the concentration.

The amount of boric acid and/or borate comprised in the binder compositions of the invention is generally 0.05% to 15% by weight, preferably 0.1% to 10% by weight, and especially 0.1% to 5% by weight, with respect to the polymer (P).

For the advantageous effect of the boric acid and/or of the borate, the pH of the binder composition of the invention is not critical. In general, however, the pH is situated in the range from 2 to 10.

The boric acid and/or borates may be added before, during or after the polymerization of the polymer (P). Alternatively they may also be added during the preparation of the binder composition.

For preparing an aqueous binder composition, the boric acid and/or the borates are added preferably to a polymer dispersion of the polymer (P) in solid form, in the form of a dispersion or a solution, and are distributed uniformly therein. The addition is made typically in solid form or as an aqueous solution. A solid binder composition is preferably obtained by drying an aqueous binder composition. In a further preferred procedure it is prepared by mixing a polymer (P) in powder form with boric acid and/or the borates.

Boric acid and borates give the binder composition of the invention properties that are advantageous for different fields of application. For example, the binder compositions, as a constituent of adhesive formulations, enhance their adhesion and cohesion properties, and in particular increase the cohesion of an adhesively bonded assembly, without significantly detracting from the adhesion. In binders for coating compositions, they enhance the blocking resistance of the coatings even at elevated temperature, without adversely affecting the flexibility of the coating. In polymer-bonded nonwovens, for example, they result in an improvement in thermal stability, i.e., the assembly of polymeric binder and nonwoven remains intact even at elevated temperature. In contrast to other covalent crosslinking agents, the boric acid and/or salts thereof do not adversely affect the storage stability of the binder compositions of the invention, particularly the aqueous binder compositions.

How the advantageous effects of the boric acid and the borates at a molecular level may be explained is of secondary importance for the invention. Nevertheless, it is thought that boric acid and borates enter into covalent or coordinative interactions with the functional groups of the polymer (P), more particularly with the vicinal hydroxyl groups. The interactions are thought to be based primarily on covalent or coordinative bonds, e.g., by the formation of cyclic boric ester structures. A boric acid or borate molecule, accordingly, is able to interact with two or more functional groups of the polymer (P) and hence develop a crosslinking action. In particular it is supposed that the boric acid is able, with the vicinal hydroxyl groups of the monomer M2, to form cyclic ester structures, meaning that covalent or at least coordinative interactions are present. Since this ester formation is probably an equilibrium reaction, reversibility exists in the case of the covalent or coordinative interaction as well. It is further thought that the abovementioned advantageous properties of the binder compositions of the invention and also of the polymer films obtainable from them can be attributed to the stated covalent or coordinative interactions, which are most probably reversible. Thus, for example, it is possible to imagine that the high strength combined with high flexibility of the polymer films formed from the binders of the invention derives from the reversible distribution of the crosslinking nodes, generated by boric acid or borates, in the polymer (P). In this case, boric acid and borates give the polymer film first an advantageous strength and hardness, by virtue of the crosslinking, and second a high flexibility and low susceptibility to fracture, by virtue of the capacity to part bonds at one point in the polymer and form them anew at another point. This is manifested, for example, in the case of coatings in a high blocking resistance in conjunction with high flexibility; in adhesives, in a high level of cohesion of the layer of adhesive; and, in the case of polymer-bonded nonwoven fabrics (nonwovens), in a high thermal stability. Presumably owing to the reversibility of bond formation, there is no adverse effect on the shelf life of the binder compositions of the invention, particularly the aqueous binder compositions.

The performance properties of coating films based on the binder compositions of the invention can be modified by varying the amount of boric acid and/or borate. For example, by optimizing the amount of borate, it is possible to maximize a specific property of coating materials, such as the adhesion of the coating to the substrate, for instance, or a weighting of different properties, such as adhesion and cohesion in an adhesive, or the thermal stability and flexibility of a polymer-bonded nonwoven fabric, for instance, can be performed in accordance with the requirements.

The binder compositions of the invention are suitable for a multiplicity of applications in which aqueous polymer dispersions are typically used as binders, e.g., coating materials, such as, for example, in paints for internal and external applications, in paper coating slips, in leather and textile coating systems, in printing inks, in coating systems for mineral moldings, in primers for coating metals, as binders in the production of polymer-bonded nonwoven fabrics, as base materials for adhesive, as additives for inorganic, hydraulic binders, such as CaSO_{4.}0.5 H₂O, anhydrite or cement and for the hydraulically setting compositions produced therefrom such as plaster or concrete, as additives for clay or loam construction materials, for producing membranes, and the like.

The binder compositions of the invention, especially the aqueous binder compositions, are employed preferably in aqueous surface coating materials. Accordingly the present invention further provides for the use of the here-described binder compositions in surface coating formulations.

The binder compositions that are employed in the surface coating materials comprise polymers (P) whose glass transition temperatures T_{g} are situated typically in the range from 0° C. to 50° C., preferably in the range from 5° C. to 45° C., and more particularly in the range from 5° C. to 40° C.

Besides the binder compositions, the surface coating formulations may comprise further adjuvants, of the kind typical in surface coating materials based on aqueous polymer dispersions. These adjuvants include pigments, fillers, further auxiliaries, and, if appropriate, additional film-forming polymers.

Suitable pigments are, for example, inorganic white pigments such as titanium dioxide, preferably in the rutile form, barium sulfate, zinc oxide, zinc sulfide, basic lead carbonate, antimony trioxide, lithopones (zinc sulfide+barium sulfate) or colored pigments, examples being iron oxides, carbon black, graphite, zinc yellow, zinc green, ultramarine, manganese black, antimony black, manganese violet, Paris blue or Schweinfurt green. As well as the inorganic pigments, the emulsion paints of the invention may also comprise organic color pigments, examples being sepia, gamboge, Cassel brown, toluidine red, parared, Hansa yellow, indigo, azo dyes, anthraquinonoid and indigoida dyes, and also dioxazine, quinacridone, phthalocyanine, isoindolinone, and metal-complex pigments. Also suitable are synthetic white pigments with air inclusions for increasing the light scattering, such as the Rhopaque® dispersions.

Suitable fillers are, for example, aluminosilicates, such as feldspars, silicates, such as kaolin, talc, mica, magnesite, alkaline earth metal carbonates, such as calcium carbonate, in the form of calcite or chalk, for example, magnesium carbonate, dolomite, alkaline earth metal sulfates, such as calcium sulfate, silicon dioxide, etc. In surface coating materials, of course, finely divided fillers are preferred. The fillers can be used as individual components. In actual practice, however, filler mixtures have been found particularly appropriate, examples being calcium carbonate/kaolin, and calcium carbonate/talc. Glossy surface coating materials generally include only small amounts of very finely divided fillers, or comprise no fillers.

Finely divided fillers may also be used to increase the hiding power and/or to save on white pigments. In order to adjust the hiding power, the hue, and the depth of color, it is preferred to use blends of color pigments and fillers.

The typical auxiliaries, besides the emulsifiers used in the polymerization, also include wetting agents or dispersants, such as sodium, potassium or ammonium polyphosphates, alkali metal salts and ammonium salts of acrylic acid or maleic anhydride copolymers, polyphosphonates, such as sodium 1-hydroxyethane-1,1-diphosphonate, and salts of naphthalenesulfonic acids, more particularly their sodium salts.

Further suitable auxiliaries are flow control agents, defoamers, biocides, thickeners, and film-forming assistants. Examples of suitable thickeners are associative thickeners, such as polyurethane thickeners. The amount of the thickener is preferably less than 1% by weight, more preferably less than 0.6% by weight, based on the solids content of the surface coating material. Suitable film-forming assistants are, in particular, organic solvents which lower the film-forming temperature of the coating material. They include, in particular, aromatic and aliphatic hydrocarbon solvents and aliphatic esters, especially dialkyl dicarboxylates, the film-forming agents typically having boiling points (under atmospheric pressure) in the range from 80 to 250° C. and being used in an amount of 0.5% to 10% by weight, based on the polymer (P).

The fraction of pigments may be described through the pigment volume concentration (PVC). The PVC describes the ratio of the volume of pigments (V_{P}) and fillers (V_{F}) to the total volume, consisting of the volumes of binder (V_{B}), pigments, and fillers in a dried coating film, in percent: PVC=(V_{P}+V_{F})×100/(V_{P}+V_{F}+V_{B}) (cf. Ullmann's Enzyklopädie der technischen Chemie, 4^{th} edition, Volume 15, p. 667). Surface coating materials can be divided up according to the PVC, for example, as follows:

| highly filled interior paint, wash resistant, white/matt | about ≧85 |
|---|---|
| interior paint, scrub resistant, white/matt | about 60-85 |
| semigloss paint, silk-matt | about 30-60 |
| semigloss paint, silk-gloss | about 25-35 |
| gloss paint | about 15-25 |
| exterior masonry paint, white | about 45-55 |
| clear varnish | 0 |

The surface coating materials of the invention can take the form, for example, of an unpigmented system (clear varnish) or of a pigmented system.

One subject of the invention concerns a surface coating material in the form of an aqueous composition comprising:
at least one binder composition of the invention,
at least one inorganic filler and/or at least one inorganic pigment,
at least one typical auxiliary, and water.

Preference is given to a surface coating material comprising:
10% to 60% by weight of at least one binder composition of the invention (polymer content 40 to 75% by weight),
10% to 70% by weight of inorganic fillers and/or inorganic pigments,
0.1% to 20% by weight of typical auxiliaries, and
water to 100% by weight.

One embodiment of the present invention are surface coating materials in the form of an emulsion paint. Emulsion paints generally comprise 30% to 75% by weight and preferably 40% to 65% by weight of nonvolatiles. By these are meant all constituents of the formulation that are not water, but at least the total weight of binder, filler, pigment, low-volatility solvents (boiling point above 220° C.), plasticizers for example, and polymeric auxiliaries. Of these figures, the amounts accounted for by each of the constituents are as follows:
a) 3% to 90%, more particularly 10% to 60%, by weight by the polymer dispersion (PD) of the invention (polymer content 40 to 75% by weight),
b) 0% to 85%, preferably 5% to 60%, more particularly 10% to 50%, by weight by at least one inorganic pigment,
c) 0% to 85%, more particularly 5% to 60%, by weight by inorganic fillers, and
d) 0.1% to 40%, more particularly 0.5% to 20%, by weight by typical auxiliaries.

The binder compositions of the invention are especially suitable for producing masonry paints having a PVC in the range from 30 to 65 or interior paints having a PVC in the range from 65 to 80. In addition they are especially suitable for producing semigloss or gloss paints which have, for example, a PVC in the range from 12% to 35%, preferably 15% to 30%.

The surface coating materials of the invention are produced in a known way by blending the components in mixing apparatus customary for the purpose. It has been found appropriate to prepare an aqueous paste or dispersion from the pigments, water, and, optionally, the auxiliaries, and only then to mix the polymeric binder, i.e., in general, the aqueous dispersion of the polymer, with the pigment paste or pigment dispersion.

The surface coating material of the invention can be applied to substrates in a usual way, as for example by spreading, spraying, dipping, rolling, knifecoating, etc.

The surface coating material of the invention is used preferably as an architectural coating material, i.e., to coat buildings or parts of buildings. The substrates in question may be mineral substrates such as renders, plaster or plasterboard, masonry or concrete, wood, woodbase materials, metal or paper, wallpapers for example, or plastic, PVC for example.

Preference is given to using the surface coating materials of the invention to coat interior parts of buildings, such as interior walls, interior doors, paneling, banisters, furniture, etc.

The surface coating materials of the invention are notable for ease of handling, good processing properties, and high hiding power. Moreover, the pollutant content of the surface coating materials is low. They have good performance properties, such as good water resistance, good wet adhesion, good blocking resistance, good recoatability, for example, and exhibit good flow on application. The surface coating materials are also outstandingly suitable for producing anticorrosive coatings.

The coatings produced from the surface coating materials of the invention feature a combination of good adhesion with good abrasion resistance. Said coatings, moreover, generally feature high flexibility and low fragility, which allows them, for example, to conform to a working substrate.

Furthermore, the binder compositions of the invention are employed preferably in adhesives. The present invention accordingly further provides for the use of the here-described binder compositions in adhesive formulations.

The adhesive formulations are produced preferably with aqueous binder compositions, and may be composed solely of these compositions. However, besides the aqueous binder compositions, the adhesive formulations may also comprise further adjuvants, of the kind customary in adhesives based on aqueous polymer dispersions. These adjuvants include fillers, colorants, including pigments, flow control agents, thickeners, biocides, and, optionally, further auxiliaries. Examples of such adjuvants have already been stated above. Further additives suitable for the adhesive formulations are, for example, setting retarders, such as sodium gluconate, for instance, and also tackifiers (tackifying resins). The adhesive formulations may further comprise additional, application-specific additives, such as cement in adhesives for tiles and similar floor- and wallcoverings, for example.

Tackifiers are, for example, natural resins, such as rosins, and derivatives prepared therefrom by disproportionation, isomerization, polymerization, dimerization or hydrogenation. They may be present in their salt form (with monovalent or polyvalent counterions, for example) or, preferably, in their esterified form. Alcohols used for the esterification may be monohydric or polyhydric. Examples are methanol, ethanediol, diethylene glycol, triethylene glycol, 1,2,3-propanetriol, pentaerythritol. Also used as tackifiers are hydrocarbon resins, examples being coumarone-indene resins, polyterpene resins, hydrocarbon resins based on unsaturated CH compounds, such as butadiene, pentene, methylbutene, isoprene, piperylene, divinylmethane, pentadiene, cyclopentene, cyclopentadiene, cyclohexadiene, styrene, a-methylstyrene, and vinyltoluene. Other tackifiers which can be used are polyacrylates which have a low molar weight. Preferably these polyacrylates have a weight-average molecular weight M_{w} below 30 000. The polyacrylates are composed preferably of at least 60%, more particularly at least 80% by weight of C₁-C₈ alkyl (meth)acrylates. Preferred tackifiers are natural or chemically modified rosins. Rosins are composed predominantly of abietic acid or derivatives thereof. The amount by weight of the tackifiers is preferably 0 to 100 parts by weight, more preferably 0 to 50 parts by weight, per 100 parts by weight of polymer (solids/solids).

The adhesives of the invention may comprise one or more tackifiers or may be free from tackifier. If tackifiers have been added to them, they generally replace a portion of the polymer (P).

The aqueous polymer dispersions used for the adhesive formulations of the invention generally have a solids content of 45% to 80%, preferably of 50% to 75%, and more particularly of 55% to 72%, by weight.

The invention provides an adhesive in the form of an aqueous composition comprising:
20% to 70% by weight of at least one binder composition of the invention (polymer content 45% to 80% by weight),
0% to 60% by weight of at least one inorganic filler and/or at least one inorganic pigment,
0% to 30% by weight of a further auxiliary, and
water to 100% by weight.

The adhesives and binder compositions of the invention are suitable in principle for producing adhesive coatings on any desired substrates such as papers, plastics, PVC for example, mineral substrates such as renders, plaster or plasterboard, masonry or concrete, wood, woodbase materials or metal.

The thickness of the coating of pressure-sensitive adhesive is dependent on the desired application and is situated typically in the range from 1 to 500 μm, more particularly in the range from 2 to 250 μm or 5 to 200 μm, corresponding to a coating of 1 to 500 g/m², more particularly 2 to 250 g/m², and especially 5 to 200 g/m².

Application of the binder compositions and adhesives to the substrates that are to be coated may take place by means of typical methods, such as by rolling, knifecoating, spreading, pouring, etc., for example. It is also possible first to apply the polymer dispersions or pressure-sensitive adhesives to a release sheet, such as a release paper, for example, and to transfer the layer of pressure-sensitive adhesive with this release medium to the desired substrate. The water comprised in the compositions is typically removed in a customary manner, such as by drying at temperature in the range from 10 to 150° C., more particularly in the range from 15 to 100° C.

The adhesives and binder compositions of the invention are especially suitable for bonding flexible floorcoverings, such as textile floorcoverings, examples being carpets, linoleum, rubber, polyolefin, CV, and PVC coverings, and also rigid floor coverings, such as woodblock floorings, and tiles. They are therefore used preferably for bonding these floorcoverings to—in particular—the aforementioned mineral substrates or substrates of wood or woodbase materials.

The glass transition temperature T_{g} of the polymers (P) used for the flooring adhesives of the invention is, in the case of the adhesives for flexible coverings, typically <−5° C., preferably <−10° C., and more particularly <−15° C., and, in the case of the adhesives for rigid coverings, woodblock flooring more particularly, is typically <20° C., preferably <15° C., and in particular <10° C.

The adhesives of the invention have very good adhesive properties, in particular a good adhesion to the substrates to be bonded, and a high cohesion (internal strength in the layer of adhesive). Furthermore, they are easy to handle and have good processing properties. With respect to the bonding of flexible floorcoverings, they are distinguished relative to prior-art adhesives by significantly increased peel strength in tandem with consistently good further properties, especially the wet grab and dry grab. In the context of their use as an adhesive for rigid floorcoverings, adhesives of the invention exhibit improved ultimate strength.

The inventive use of boric acid and/or borate for external polymer crosslinking also makes it possible to formulate the adhesives of the invention as storage-stable one-component formulations. In contrast, in the case of prior-art adhesives, the crosslinker that forms covalent bonds must be stored in a second, separate component, since it would otherwise lead to premature, irreversible curing.

The binder compositions of the invention are also suitable in particular for producing polymer-bonded nonwoven fabrics or nonwovens, respectively.

For producing polymer-bonded nonwoven fabrics, for example, an unbonded nonwoven fabric is treated with at least one aqueous binder composition of the invention. The aqueous binder composition for this purpose is used generally in an amount of 0.5% to 30%, preferably 1.5% to 20%, by weight, based on the weight of the nonwoven material and calculated as solids content of the binder composition. The binder is used to consolidate the nonwoven fabrics. The treatment of the unbonded nonwoven fabrics may take place, for example, by spraying, dipping, impregnating or padding or by treatment of the nonwoven fabrics with a binder composition in the form of a foam.

The unbonded nonwoven fabrics may be composed of natural and/or synthetic fibers. Examples of natural fibers are cellulosic fibers of various origins, such as chemical pulp and viscose rayon staple, and also fibers composed of cotton, hemp, jute, sisal, and wood, wool, and blends of at least two of the stated fiber types. Fibers used with preference from the group are fibers composed of jute, sisal, and wood. Examples of synthetic fibers are viscose, polyester, polyamide, polypropylene, polyethylene, polyacrylonitrile, and polyvinyl chloride fibers, and also carbon fibers, glass fibers, ceramic fibers, and mineral fibers, and also blends of at least two of the stated fiber types. For producing the bonded nonwoven fabrics it is preferred to use polyester fibers and also blends of polyester fibers and glass fibers. Polyester fibers may be obtained from recycled material by melt spinning and used to produce a nonwoven support material. The nonwoven materials may be composed, for example, of staple fibers or of spun fibers, and also of blends of these fiber types. Unbonded nonwoven fabrics are produced, as is known, mechanically by needling or water jet consolidation of a wet-laid or air-laid nonwoven material. The nonwoven materials have, for example, a basis weight of 10 to 700 g/m², preferably of 50 to 500 g/m². Usually the basis weight of the nonwoven materials prior to consolidation is 75 to 300 g/m².

The nonwoven fabrics treated with the binder composition of the invention are heated for consolidation to temperatures usually in the range from 100° C. to 230° C., preferably 120 to 210° C. The heating time is dependent essentially on the temperature, the water content, and the particular fiber of which the nonwoven fabric is composed. The nonwoven fabrics treated with the binder composition of the invention are usually heated for 0.5 to 5, preferably 1.5 to 3, minutes. In the course of heating, water vapor escapes to start with, accompanied or followed by the filming of the polymer P present in the binder composition, which undergoes crosslinking with the boric acid and/or salts thereof.

Where the binders are used for nonwoven fabrics, the binder compositions of the invention may further comprise typical adjuvants, such as finely divided inert fillers, such as aluminum silicates, quartz, precipitated or fumed silica, light spar and heavy spar, talc, dolomite or calcium carbonate; color-imparting pigments, such as titanium white, zinc white, black iron oxide, etc., foam inhibitors; foam formers, thickeners; preservatives; lubricants and/or wetting agents.

For certain applications it is advantageous, rather than the aqueous binder composition of the invention, to use a solid binder composition in powder form, comprising a water-insoluble polymer (P) as herein defined, and boric acid or a salt of boric acid. Such powders may for example be prepared by removing water and, optionally, other volatile components from the aqueous binder composition, preferably by means of a conventional drying process for powder preparation, more particularly by a spray drying process. Alternatively an aqueous dispersion of the polymer can first be converted to a powder by a suitable drying process and, during or after the drying process, the powder can be admixed with the desired amount of boric acid or a salt thereof. These solid binder compositions in powder form are employed, for example, in inorganic, hydraulically setting binders such as calcium sulfate semihydrate, anhydrite or cement, since they endow the binding construction materials produced therefrom, such as concrete, cement plasters, and gypsum-containing materials, with advantageous physical properties, especially improved strength, such as tensile strength and breaking strength.

The figures and the examples which follow serve to illustrate the invention.

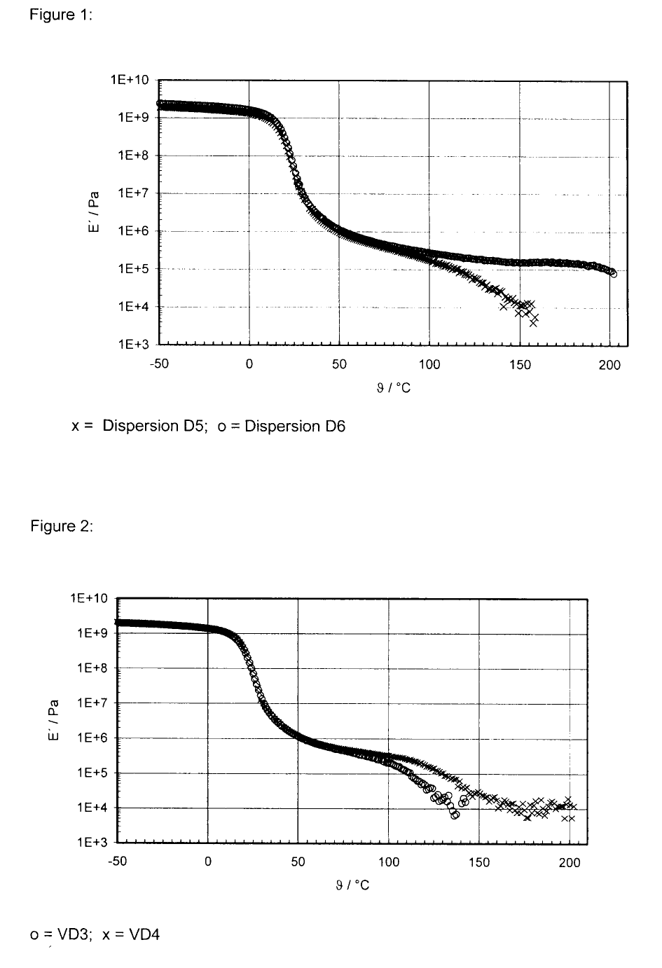

FIG. 1 shows the storage moduli as determined by means of dynamic-mechanical analysis for the polymer films produced from the dispersions of examples 5 (VD5, without borate) and 6 (VD6, with borate), as a function of temperature.

FIG. 2 shows the storage moduli as determined by means of dynamic-mechanical analysis for the polymer films produced from the dispersions of comparative examples 3 (VD3, without borate) and 4 (VD4, with borate), as a function of temperature.

From FIG. 1 it is apparent that the addition of the boric acid (example 6) significantly increases the storage modulus of the polymer film at temperatures above 90° C. and that this level is retained at temperatures up to about 200° C., whereas, without the addition of boric acid/borate, the level at 150° C. has dropped to approximately 1/10 of the value at 100° C. The comparison of FIG. 1 with FIG. 2, in turn, shows that, in the case of polymers comprising in copolymerized form monomers having only 1 hydroxyl group, the addition of boric acid/borate does significantly raise the storage modulus of the polymer film at temperatures above 90° C., but that the level drops sharply even at temperatures below 130° C. and at just 160° C. has fallen to approximately 1/10 of the value at 100° C. It is apparent, moreover, that the polymers which comprise in copolymerized form monomers having vicinal OH groups, in comparison to polymers which comprise in copolymerized form monomers having only one OH group, exhibit a significantly higher storage modulus at temperatures above 100° C.

### I Analysis

Determination of the solvent absorption and the gel content 42 g of each dispersion (diluted with water to 25%) were poured into a rubber mold having a base area of 15 cm×7 cm. The dispersion was filmed at 20° C. and the resulting polymer film was then dried on a piece of gauze at 20° C. for two weeks. A specimen weighing 0.5 to 1 g was cut from the polymer film produced and dried as above. The specimen was weighed (m1) and admixed with 100 ml of the solvent in a closeable screw-top glass container. Following storage of the specimen in the solvent for 24 hours, the specimen was removed from the solvent and weighed in the wet state (m2). The wet specimen was subsequently dried at room temperature for 48 hours and then at 60° C. for 48 hours in a drying cabinet, and the mass of the dried specimen was ascertained (m3). The gel content was calculated from (m3/m1)×100%. The solvent absorption was calculated from ((m2−m1)/m1)×100%.

### Determination of the Pendulum Hardness

Each of the dispersions was applied to glass in a wet film thickness of 250 μm and dried at 50° C. for 24 h. The Konig pendulum hardness was then determined in accordance with DIN 53157.

### Determination of the Light Transmittance

The light transmittance, (LT) was determined photometrically using a photometer on a 0.01% by weight dilution of the dispersion at 23° C.

### Determination of the Average Particle Diameter

The average particle diameter was determined by means of photon correlation spectroscopy (PCS), also known as quasielastic light scattering (QELS) or dynamic light scattering. The measurement method is described in the IS013321 standard. The determination was carried out using an HPPS (High Performance Particle Sizer). For this purpose, a highly diluted aqueous polymer dispersion (c˜0.005%) was analyzed. Measurement configuration: HPPS from Malvern, automated, with continuous-flow cuvette and Gilson autosampler. Parameters: measurement temperature 22.0° C.; measurement time 120 seconds (6 cycles each of 20 s); scattering angle 173°; wavelength laser 633 nm (HeNe); refractive index of medium 1.332 (aqueous); viscosity 0.9546 mPas. The measurement gave an average value of the cumulant analysis (mean of fits). The mean of fits is an average, intensity-weighted particle diameter in nm, which corresponds to the volume-average or mass-average particle diameter.

The average particle diameters can alternatively be determined by the method described by H. Cölfen, “Analytical Ultracentrifugation of Nanoparticles”, in Encyclopedia of Nanoscience and Nanotechnology, (American Scientific Publishers, 2004), pp. 67-88. For this purpose an investigation is carried out at 23° C. on a 0.1 to 0.5% by weight dilution (relative to solids content; light transmittance about 10%) of the polymer dispersion by means of an ultracentrifuge (Beckmann Model XL type) in a sedimentation field ramp from 600 to 40 000 rpm in accordance with an acceleration of 2250 to 150 000 g using a turbidity-based optical system (see also W. Mächtle and L. Böger in “Analytical Ultracentrifugation of Polymers and Nanoparticles”, (Springer, Berlin, 2006), W. Machtle in Analytical Ultracentrifugation in Biochemistry and Polymer Science: S. E. Harting et al. (editors), Cambridge: Royal Society of Chemistry, 1992, pp. 147-175, and in W. Mächtle, Makromolekulare Chemie 185 (1984), pages 1025-1039). The diluent used was D₂O with about 0.1 to 0.5 g/l, e.g., 0.5 g/l of Emulgator K30 (emulsifier: sodium salt of an alkanesulfonate).

### Determination of the Viscosity

The Brookfield viscosity was determined by a method based on DIN EN ISO 3219, using a rotational viscometer (Physica MCR 301 rheometer with sample changer and CC₂₇ measuring system from Anton Paar) at 23° and a shear rate of 0 to 500 sec⁻¹). The figure given is the value at 100 sec⁻¹.

### Dynamic-Mechanical Analysis (DMTA)

The dynamic-mechanical analysis (DMTA) was performed using a rheometrics solids analyzer RSA II in a measuring-temperature range from −30° C. to +200° C., with a heating rate of 2° C./min and a frequency f of 1 Hz. For the dispersion films under measurement, the storage moduli E′, the loss moduli E″, and tan δ were ascertained (sample geometry: 34.5 mm length, 6.0 mm width, between 0.645 and 0.975 mm thickness). The measurements were represented in graph form by plotting E′, E″, and tan S against the temperature. The glass transition temperature Tg was determined from the E″ graphs.

### II Preparation of the Polymer Dispersions

Emulsifier 1: Alkyldiphenyl oxide disulfonate (Dowfax® 2A1);
Emulsifier 2: C₁₃ oxo-process alcohol polyethoxylate having 8 ethylene oxide units, 20% in water;
Emulsifier 3: ethoxylate of secondary C₁₁-C₁₅ alkanols with 12 ethylene oxide units: Softanol 120 (Tergitol 15-S-12, Dow),
Emulsifier 4: alpha-sulfo-omega-[1-(alkoxy)methyl-2-(2-propenyloxy)ethoxy]-poly(oxy-1,2-ethanediyl), ammonium salt (Adeka Reasoap SR-1025:)
Biocide 1: Acticid MBS, from Thor, mixture of methyl-4-isothiazoline and 1,2-benzisothiazolin-3-one
Biocide 2: Acticid MV, from Thor, mixture of chloromethylisothiazolinone and methylisothiazolinone

### EXAMPLE 1

### Dispersion D1

A polymerization vessel equipped with metering apparatus, stirrer, and temperature regulation was charged with 163 g of deionized water and 27.8 g of polystyrene seed latex (with weight-average particle size of 30 nm and a solids content of 32.4% by weight). The apparatus was then flushed with nitrogen and the initial charge was heated to 95° C. While this temperature was maintained, 2.06 g of aqueous sodium peroxodisulfate solution (7% by weight solids content) were added and stirring was continued for 5 minutes. Then 18.5 g of aqueous sodium peroxodisulfate solution (7% by weight solids content) were metered in and, in parallel therewith, the continuously stirred monomer emulsion, consisting of 260 g of water, 12.0 g of emulsifier 1 (solids content 45% by weight), 36.0 g of emulsifier 2 (solids content 20% by weight), 9.60 g of methacrylic acid, 314 g of methyl methacrylate, 252 g of n-butyl acrylate, and 24.0 g of a mixture of 1-methacrylamido-2-D-gluconylaminoethane (mass fraction 89% by weight) and methacrylic acid (mass fraction 11% by weight), was metered in at a constant feed rate over the course of 165 minutes. After the end of the feeds, the feed vessel for the monomer emulsion was rinsed with 20.8 g of water into the polymerization vessel. This was followed by stirring at 95° C. for 15 minutes, after which 2.40 g of aqueous ammonia solution (solids content 25% by weight) were added. Thereafter a mixture of 3.60 g of aqueous tert-butyl hydroperoxide solution (solids content 10% by weight) and 12.0 g of deionized water and, in parallel therewith, a mixture of an aqueous solution of 4.58 g of acetone bisulfite (solids content 13.1% by weight) and 12.0 g of deionized water, were metered in at a constant feed rate over the course of 60 minutes. After that the reaction mixture was stirred at 95° C. for a further 15 minutes, before 54.0 g of deionized water were added and the reaction mixture obtained was cooled to 30° C. When a temperature of 30° C. was reached, 7.80 g of aqueous sodium hydroxide solution (solids content 10% by weight), 3.60 g of biocide 1 (solids content 5% by weight), and 1.12 g of biocide 2 (solids content 1.5% by weight) were added in succession.

This gave a polymer dispersion having a solids content of 50.6%, a pH of 8.2, and an average particle size of 123 nm (HPPS). The gel fraction in THF was 84%, and the THF absorption was 740%. The pendulum hardness was 34 s. The storage modulus as determined by DMTA analysis is 78.7×10⁵ Pa (60° C.), 11.8×10⁵ Pa (100° C.), 2.54×10⁵ Pa (150° C.), and the glass transition temperature Tg determined from the maximum of the loss modulus, was 31° C.

### EXAMPLE 2

### Dispersion D2

Preparation took place as described for example 1, monomers used being 7.20 g of methacrylic acid, 292 g of methyl methacrylate, and 48.0 g of the mixture of 1-methacrylamido-2-D-gluconylaminoethane (mass fraction 89%) and methacrylic acid (mass fraction 11% by weight).

This gave a polymer dispersion having a solids content of 49.8%, a pH of 8.2, and an average particle size of 130 nm (HPPS). The gel fraction in THF was 90%, and the THF absorption was 480%. The pendulum hardness was 28 s. The storage modulus as determined by DMTA analysis was 207×10⁵ Pa (60° C.), 36.6 x 10⁵ Pa (100° C.), 4.54×10⁵ Pa (150° C.), and the glass transition temperature Tg determined from the maximum of the loss modulus, was 25° C.

### EXAMPLE 3

### Dispersion D3

The polymer dispersion D1 was admixed with 67.2 g of an aqueous solution of disodium tetraborate decahydrate (solids content 5% by weight).

The gel fraction in THF was 97% and the THF absorption was 470%. The pendulum hardness was 38 s. The storage modulus as determined by DMTA analysis was 157×10⁵ Pa (60° C.), 54.7×10⁵ Pa (100° C.), 15.4×10⁵ Pa (150° C.), and the glass transition temperature Tg determined from the maximum of the loss modulus was 31° C.

### EXAMPLE 4

### Dispersion D4

200 g of the polymer dispersion D2 were admixed, with thorough mixing, with 21.6 g of an aqueous solution of disodium tetraborate decahydrate (solids content 5% by weight).

The gel fraction in THF was 93% and the THF absorption was 300%. The pendulum hardness was 34 s. The storage modulus as determined by DMTA analysis was 389×10⁵ Pa (60° C.), 310×10⁵ Pa (100° C.), 144×10⁵ Pa (150° C.), and the glass transition temperature Tg determined from the maximum of the loss modulus was 25° C.

### EXAMPLE 5

### Dispersion D5

A 2 l polymerization vessel equipped with metering apparatus, temperature regulation, and anchor stirrer was charged at room temperature under a nitrogen atmosphere with 422.5 g of deionized water, 6.25 g of emulsifier 3, 5 g of emulsifier 4, and the mixture was heated with stirring. When an internal temperature of 85° C. was reached, an initiator solution of 2.5 g of ammonium persulfate, 1.25 g of sodium carbonate in 58.8 g of deionized water was added and the internal temperature was maintained at 85° C. over the further course. Five minutes after the addition of this initiator solution, the two feeds Z1 and Z2 were metered in parallel over the course of 60 minutes at a constant rate with stirring. Subsequently the feeds Z3 and Z4 were metered in over the course of 50 minutes in parallel at a constant rate. Finally, for postpolymerization, feeds Z5 and

Z6 were metered in parallel over the course of 30 minutes at 85° C., followed by cooling to room temperature.

Z1

| | | |
|---|---|---|
| 89.4 | g | deionized water |
| 45 | g | emulsifier 4 |

Z2

| | | |
|---|---|---|
| 125 | g | n-butyl acrylate |
| 125 | g | styrene |

Z3

| | | |
|---|---|---|
| 55.9 | | deionized water |
| 25 | g | glycoside acrylate |

Z4:

| | | |
|---|---|---|
| 125 | g | n-butyl acrylate |
| 125 | g | methyl methacrylate |

Z5

| | | |
|---|---|---|
| 4 | g | aqueous acetone bisulfite solution, |
| | | 13% strength by weight |

Z6

| | | |
|---|---|---|
| 3 | g | aqueous t-butyl hydroperoxide solution, |
| | | 10% strength by weight |

This gave a polymer dispersion having a solids content of 42.9% by weight, a pH of 8.6, and an average particle size of 94 nm (dynamic light scattering). The gel fraction in toluene was 20% and the toluene absorption was 20%. The storage modulus as determined by DMTA analysis was 6×10⁵ Pa (60° C.), 2×10⁵ Pa (100° C.), 1×10⁴ Pa (150° C.), and the glass transition temperature Tg, determined from the maximum of the loss modulus, was 17° C. The Brookfield viscosity was 70 mPas.

### EXAMPLE 6

### Dispersion D6

100 g of dispersion D5 were admixed with 1.24 g of a 10% strength by weight disodium octaborate tetrahydrate solution.

This gave a polymer dispersion having a solids content of 42.6% by weight, a pH of 8.5, and an average particle size of 96 nm (dynamic light scattering). The gel fraction in toluene was 65%, and the toluene absorption was 65%. The storage modulus as determined by DMTA analysis was 7.5×10⁵ Pa (60° C.), 3.0×10⁵ Pa (100° C.), 1.2×10⁵ Pa (150° C.), and the glass transition temperature Tg determined from the maximum of the loss modulus, was 18° C.

### PREPARATION EXAMPLE 7

### Dispersion D7

A polymerization vessel equipped with metering apparatus and temperature regulation was charged at 20 to 25° C. (room temperature) under a nitrogen atmosphere with 290.9 g of deionized water and 12.0 g of a 15% strength by weight aqueous solution of sodium lauryl sulfate, and this initial charge was heated to 80° C. with stirring. When this temperature was reached, 25.7 g of a 7% strength by weight aqueous solution of sodium peroxodisulfate were added and the batch was stirred for two minutes. Then, with the temperature maintained, feed Z1 was metered in continuously over the course of 40 minutes at a constant flow rate. After the end of the addition of feed Z1, 12.0 g of deionized water were added to the polymerization mixture. The polymerization mixture was then afterreacted at 80° C. for 10 minutes. Subsequently 1.9 g of a 3% strength by weight aqueous ammonia solution were metered continuously into the polymerization mixture over the course of 10 minutes with a constant flow rate. After that, over the course of 90 minutes, with a constant flow rate, feed Z2 was metered in continuously. 40 minutes after the beginning of feed 2, and in parallel with the ongoing feed 2, 0.9 g of a 3% strength by weight aqueous ammonia solution was metered into the polymerization mixture over the course of 10 minutes, continuously and with a constant flow rate. After the end of feed Z2, 12 g of water were added to the polymerization mixture. Thereafter the polymerization mixture was afterreacted at 80° C. for 90 minutes more. After that, 1.7 g of a 5% strength by weight aqueous ammonia solution was metered into the polymerization mixture over the course of 10 minutes, continuously and with a constant flow rate. The aqueous polymer dispersion obtained was then cooled to room temperature and filtered through a 125 μm filter.

Z1 (homogeneous mixture of):

| | | |
|---|---|---|
| 75.0 | g | deionized water |
| 3.0 | g | a 15% strength by weight aqueous solution of |
| | | sodium lauryl sulfate |
| 6.8 | g | glycidyl methacrylate |
| 38.25 | g | n-butyl acrylate |
| 90.0 | g | methyl methacrylate |

Z2 (homogeneous mixture of):

| | | |
|---|---|---|
| 186.1 | g | deionized water |
| 6.0 | g | a 15% strength by weight aqueous solution of |
| | | sodium lauryl sulfate |
| 221.4 | g | n-butyl acrylate |
| 93.6 | g | methyl methacrylate |

The aqueous polymer dispersion obtained had a solids content of 42.4% by weight. The weight-average particle diameter of the polymer dispersion was 79 nm. The water absorption of a dispersion film, obtainable by pouring the dispersion into a rubber plate and drying it at room temperature for 7 days, was 5.3% after 24 h and 7.3% after 48 h. The loss of this film on washing was 0.05%. The loss of this film on washing in toluene was 97.0% after 24 h.

### EXAMPLE 8

### Dispersion D8

740 g of the aqueous polymer dispersion D7 obtained according to example 7 were mixed with 12.37 g of a 5% strength by weight aqueous disodium tetraborate decahydrate solution at room temperature.

The water absorption of a dispersion film, obtainable by pouring the dispersion into a rubber plate and drying it at room temperature for 7 days, was 5.6% after 24 h and 7.6% after 48 h. The loss of this film on washing was 0.10%. The loss of this film on washing in toluene was 89.2% after 24 h.

### PREPARATION EXAMPLE 9

### Dispersion D9

The polymer dispersion was prepared in the same way as the instructions from example 7, with the difference that additionally 0.9 g of disodium tetraborate was included in the initial charge, and 187.3 g of deionized water were used in feed 2.

The aqueous polymer dispersion obtained had a solids content of 42.6% by weight.

The weight-average particle diameter of the polymer dispersion was 77 nm. The water absorption of a dispersion film, obtainable by pouring the dispersion into a rubber plate and drying it at room temperature for 7 days, was 7.2% after 24 h and 9.7% after 48 h. The loss of this film on washing was 0.12%. The loss of this film on washing in toluene was only 8.0% after 24 h.

### COMPARATIVE EXAMPLE 1

### Dispersion VD1

Preparation took place as described for example 1. However, 12. 0 g of methacrylic acid, 336 g of methyl methacrylate, and 202 g of n-butyl acrylate were used, and, instead of the mixture of 1-methacrylamido-2-D-gluconylaminoethane and methacrylic acid, 49.8 g of butanediol monoacrylate were used.

This gave a polymer dispersion having a solids content of 51.1% by weight, a pH of 8.3, and an average particle size of 122 nm (determined by means of HPPS). The gel fraction in THF was 80%, and the THF absorption was 1500%. The pendulum hardness was 41 s. The storage modulus as determined by DMTA analysis was 20.1×10⁵ Pa (60° C.), 4.91×10⁵ Pa (100° C.), 1.87×10⁵ Pa (150° C.), and the glass transition temperature Tg determined from the maximum of the loss modulus, was 26° C.

### COMPARATIVE EXAMPLE 2

### Dispersion VD2

200 g of the polymer dispersion from comparative example 1 were admixed, and mixed thoroughly, with 10.8 g of an aqueous solution of disodium tetraborate decahydrate (solids content 5% by weight).

The gel fraction in THF was 82% and the THF absorption was 2200%. The pendulum hardness was 41 s. The storage modulus as determined by DMTA analysis was 29.5×10⁵ Pa (60° C.), 5.95×10⁵ Pa (100° C.), 3.03×10⁵ Pa (150° C.), and the Tg determined from the maximum of the loss modulus was 30° C.

### COMPARATIVE EXAMPLE 3

### Dispersion VD3

Preparation took place as described for example 5. In the feed Z3, the 25 g of glycoside acrylate were replaced by 25 g of 2-hydroxyethyl methacrylate.

This gave a polymer dispersion having a solids content of 44.3% by weight, a pH of 6.4, and an average particle size of 105 nm (dynamic light scattering). The gel fraction in toluene was 6%. The storage modulus as determined by DMTA analysis was 7×10⁵ Pa (60° C.), 2×10⁵ Pa (100° C.), <1×10⁴ Pa (150° C)*, and the glass transition temperature Tg determined from the maximum of the loss modulus, was 17° C. The Brookfield viscosity was 100 mPas. *value below measurement limit of 10⁴ Pa.

### COMPARATIVE EXAMPLE 4

### (Dispersion VD4

100 g of the polymer dispersion from comparative example 3 were admixed with 0.8 g of a 10% strength by weight sodium octaborate solution (corresponding to a molar ratio of OH to boron of 10:1).

This gave a polymer dispersion having a solids content of 44.2% by weight, a pH of 8.4, and an average particle size of 103 nm (dynamic light scattering). The gel fraction in toluene was 7%. The storage modulus as determined by DMTA analysis was 7×10⁵ Pa (60° C.), 3×10⁵ Pa (100° C.), 2×10⁴ Pa (150° C.), and the glass transition temperature Tg determined from the maximum of the loss modulus, was 17° C.

### COMPARATIVE EXAMPLE 5

### Dispersion VD5

Preparation took place in the same way as for the preparation of example 7, except that in feed 1 12.6 g of hydroxyethyl methacrylate were used instead of 6.8 g of glycidyl methacrylate.

The aqueous polymer dispersion obtained had a solids content of 42.3% by weight. The weight-average particle diameter of the polymer dispersion was 83 nm. The water absorption of a dispersion film, obtainable by pouring the dispersion into a rubber plate and drying it at room temperature for 7 days, was 5.6% after 24 h and 7.5% after 48 h. The loss of this film on washing was 0.09%. The loss of this film on washing in toluene was 97.6% after 24 h.

### COMPARATIVE EXAMPLE 6

### Dispersion VD6

Of the aqueous polymer dispersion obtained according to comparative example 5, 740 g were mixed with 12.37 g of a 5% strength aqueous disodium tetraborate decahydrate solution at room temperature.

The water absorption of a dispersion film, obtainable by pouring the dispersion into a rubber plate and drying it at room temperature for 7 days, was 6.0% after 24 h and 8.0% after 48 h. The loss of this film on washing was 0.13%. The loss of this film on washing in toluene was 95.1% after 24 h.

1. An aqueous binder composition comprising
a) a water-insoluble polymer P in the form of dispersed polymer particles which is obtainable by polymerization of ethylenically unsaturated monomers M, the monomers M comprising:
90% to 99.9% by weight, based on the total amount of monomers M, of at least one neutral, monoethylenically unsaturated monomer M1 of low water-solubility; and
0.1% to 10% by weight, based on the total amount of monomers M, of at least one monoethylenically unsaturated monomer M2 which is selected from monoethylenically unsaturated monomers which have at least two hydroxyl groups attached to vicinal C atoms, and monoethylenically unsaturated monomers which carry a functional group which can be converted by hydrolysis into two hydroxyl groups attached to vicinal C atoms;
and
b) boric acid and/or at least one salt of boric acid.

2. The aqueous binder composition according to claim 1, the at least one monomer M1 being selected from esters and diesters of monoethylenically unsaturated C₃-C₈ monocarboxylic and C₄-C₈ dicarboxylic acids with C₁-C₃₀ alkanols, esters of vinyl alcohol or allyl alcohol with C₁-C₃₀ monocarboxylic acids, vinylaromatics, amides and diamides, monoethylenically unsaturated C₃-C₈ monocarboxylic and C₄-C₈ dicarboxylic acids with C₁-C₃₀ alkylamines or di-C₁-C₃₀ alkylamines, and mixtures thereof.

3. The aqueous binder composition according to any of the preceding claims, the monomers M2 being selected from monoethylenically unsaturated monomers which have at least two hydroxyl groups attached to vicinal C atoms.

4. The aqueous binder composition according to claim 3, the monomers M2 being selected from monomers of the general formula I 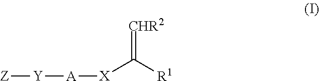
in which
R¹ is hydrogen or methyl;
R² is hydrogen or COOH;
X is O, NR³, CH₂O, CH₂NR³, C(═O)O or C(O)NR⁴, the carbon atom in the 4 last-mentioned radicals being attached to the carbon atom which carries R¹, where R³ is hydrogen, C₁-C₄ alkyl or a group Z—Y-A, and R⁴ is hydrogen or C₁-C₄ alkyl;
A is C₂-C₂₀ alkylene or a group —R⁵—O—[—R⁵—O—]ₓ—C₂-C₂₀ alkylene, where R⁵ is CH₂CH₂ or C₃H₆ and x is an integer from 0 to 20;
Y is a chemical bond, O or NR⁶, where R⁶ is hydrogen or C₁-C₄ alkyl; or
A-Y is a chemical bond or CH₂; and
Z is a radical of the formulae Z¹ or Z²; 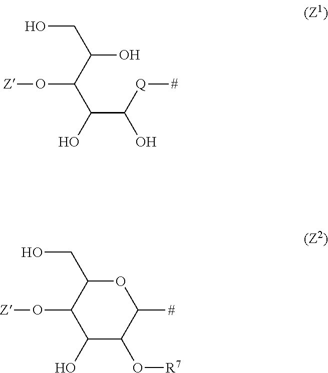
where
Q is C(O) or CH₂,
Z′ is hydrogen or a monosaccharide or oligosaccharide radical, and
R⁷ is hydrogen or methyl;

5. The aqueous binder composition according to any of the preceding claims, the monomers M2 being selected from N-allylgluconamide, N-allylaminoglucose, 2-(N-gluconylamino)ethyl vinyl ether, 3-(N-gluconylamino)propyl vinyl ether, N-[2-(gluconylamino)ethyl]maleamide, N-[3-(gluconylamino)propyl]maleamide, N-[2-(gluconylamino)ethyl-N′-methyl]maleamide, N-[3-(gluconylamino)propyl-N′-methylmaleamide, N,N-bis[2-(gluconylamino)ethyl]maleamide, N,N-bis[3-(gluconylamino)propyl]maleamide, N-[2-(acrylamido)ethyl]gluconamide, N-[2-(methacrylamido)ethyl]gluconamide, N-[3-(acrylamido)propyl]gluconamide, N-[3-(methacrylamido)propyl]gluconamide, N-methylglucaminoacrylamide, N-methylglucaminomethacrylamide, N-methylaminoglucoseacrylamide, N-methylaminoglucosemethacrylamide, N-maltoyl-N-methylacrylamide, N-maltoyl-N-methylmethacrylamide, N-allyllactobionamide, N-allylmaltobionamide, N-allylaminomaltose, N-allylaminooligomaltose, and 1-methacrylamido-2-D-gluconylaminoethane.

6. The aqueous binder composition according to any of the preceding claims, the monomers M comprising at least one monoethylenically unsaturated monomer M3 having at least one carboxylate or carboxamido group.

7. The aqueous binder composition according to claim 6, the monomer M3 being selected from monoethylenically unsaturated C₃-C₈ monocarboxylic acids and the primary amides of monoethylenically unsaturated C₃-C₈ monocarboxylic acids.

8. The aqueous binder composition according to any of the preceding claims, the monomers M further comprising at least one monomer M4 which is selected from hydroxy-C₂-C₄ alkyl esters of monoethylenically unsaturated C₃-C₈ monocarboxylic acids, monoesters of monoethylenically unsaturated C₃-C₈ carboxylic acids with polyoxy-C₂-C₄ alkylene ethers, and monoethylenically unsaturated monomers having at least one urea group.

9. The aqueous binder composition according to any of the preceding claims, the water-insoluble polymer of component a) being obtainable by free-radical, aqueous emulsion polymerization.

10. The aqueous binder composition according to any of the preceding claims, the average particle diameter of the polymer particles, determined by light scattering, being situated in the range from 0.03 to 1.5 μm.

11. The aqueous binder composition according to any of the preceding claims, the water-insoluble polymer having a glass transition temperature in the range from −60 to +60° C.

12. The aqueous binder composition according to any of the preceding claims, component b) being selected from boric acid and alkali metal salts, alkaline earth metal salts, ammonium salts, alkylammonium salts, and hydroxyalkylammonium salts of orthoboric acid or oligoboric acid having up to 20 boron atoms.

13. The aqueous binder composition according to any of the preceding claims, comprising component b) in an amount of 0.1% to 10% by weight, based on the water-insoluble polymer.

14. A solid binder composition comprising a water-insoluble polymer according to any of claims 1 to 11 in the form of a powder, and boric acid and/or at least one salt of boric acid.

15. A solid binder composition in powder form, obtainable by drying one of the aqueous binder compositions according to any of claims 1 to 13.

16. A process for preparing an aqueous binder composition according to any of claims 1 to 13, comprising the steps of
A) preparing an aqueous dispersion of a water-insoluble polymer by polymerization of ethylenically unsaturated monomers M; and
B) adding boric acid and/or at least one salt of boric acid to the polymer dispersion obtained in step A), or during its preparation.

17. An aqueous polymer dispersion of a water-insoluble polymer P which is obtainable by polymerization of ethylenically unsaturated monomers M, the monomers M comprising:
90% to 99.9% by weight, based on the total amount of monomers M, of at least one neutral, monoethylenically unsaturated monomer M1 of low water-solubility; and
0.1% to 10% by weight, based on the total amount of monomers M, of at least one monoethylenically unsaturated monomer M2 which is selected from monoethylenically unsaturated monomers which have at least two hydroxyl groups attached to vicinal C atoms.

18. The aqueous polymer dispersion according to claim 17, the at least one monomer M1 being selected from esters and diesters of monoethylenically unsaturated C₃-C₈ monocarboxylic and C₄-C₈ dicarboxylic acids with C₁-C₃₀ alkanols, esters of vinyl alcohol or allyl alcohol with Ci-C₃₀ monocarboxylic acids, vinylaromatics, amides and diamides of monoethylenically unsaturated C₃-C₈ monocarboxylic and C₄-C₈ dicarboxylic acids with C₁-C₃₀ alkylamines or di-C₁-C₃₀ alkylamines, and mixtures thereof.

19. The aqueous polymer dispersion according to either of claims 17 and 18, the monomers M2 being selected from monomers of the general formula I 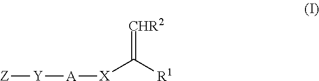
in which
R¹ is hydrogen or methyl;
R² is hydrogen or COOH;
X is O, NR³, CH₂O, CH₂NR³, C(═O)O or C(O)NR⁴, the carbon atom in the 4 last-mentioned radicals being attached to the carbon atom which carries R¹, where R³ is hydrogen, C₁-C₄ alkyl or a group Z—Y-A, and R⁴ is hydrogen or C₁-C₄ alkyl;
A is C₂-C₂₀ alkylene or a group —R⁵—O—[—R⁵—O—]—C₂-C₂₀ alkylene, where R⁵ is CH₂CH₂ or C₃H₆ and x is an integer from 0 to 20;
Y is a chemical bond, O or NR⁶, where R⁶ is hydrogen or C₁-C₄ alkyl; or
A-Y is a chemical bond or CH₂; and
Z is a radical of the formulae Z¹ or Z²; 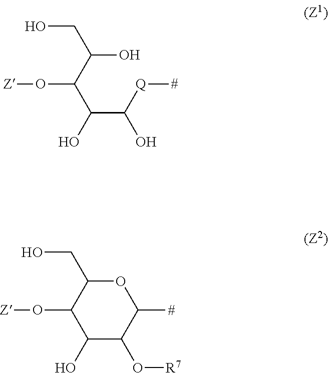
where
Q is C(O) or CH₂,
Z′ is hydrogen or a monosaccharide or oligosaccharide radical, and
R⁷ is hydrogen or methyl;

20. The aqueous polymer dispersion according to any of claims 17 to 19, the monomers M2 being selected from N-allylgluconamide, N-allylaminoglucose, 2-(N-gluconylamino)ethyl vinyl ether, 3-(N-gluconylamino)propyl vinyl ether, N-[2-(gluconylamino)ethyl]maleamide, N-[3-(gluconylamino)propyl]maleamide, N-[2-(gluconylamino)ethyl-N′-methyl]maleamide, N-[3-(gluconylamino)propyl-N′-methylmaleamide, N,N-bis[2-(gluconylamino)ethyl]maleamide, N,N-bis[3-(gluconylamino)propyl]maleamide, N-[2-(acrylamido)ethyl]gluconamide, N[-2-(methacrylamido)ethyl]gluconamide, N-[3-(acrylamido)propyl]gluconamide, N[-3-(methacrylamido)propyl]gluconamide, N-methylglucaminoacrylamide, N-methylglucaminomethacrylamide, N-methylaminoglucoseacrylamide, N-methylaminoglucosemethacrylamide, N-maltoyl-N-methylacrylamide, N-maltoyl-N-methylmethacrylamide, N-allyllactobionamide, N-allylmaltobionamide, N-allylaminomaltose, N-allylaminooligomaltose, glycidyl methacrylate, glycidyl acrylate, and 1-methacrylamido-2-D-gluconylaminoethane.

21. The aqueous polymer dispersion according to any of claims 17 to 20, the monomers M comprising at least one monoethylenically unsaturated monomer M3 having at least one carboxylate or carboxamido group.

22. The aqueous polymer dispersion according to claim 21, the monomer M3 being selected from monoethylenically unsaturated C₃-C₈ monocarboxylic acids and the primary amides of monoethylenically unsaturated C₃-C₈ monocarboxylic acids

23. The aqueous polymer dispersion according to any of claims 17 to 22, the monomers M further comprising at least one monomer M4 which is selected from hydroxy-C₂-C₄ alkyl esters of monoethylenically unsaturated C₃-C₈ monocarboxylic acids, monoesters of monoethylenically unsaturated C₃-C₈ carboxylic acids with polyoxy-C₂-C₄ alkylene ethers, and monoethylenically unsaturated monomers having at least one urea group.

24. The aqueous polymer dispersion according to any of claims 17 to 23, the water-insoluble polymer of component a) being obtainable by free-radical aqueous emulsion polymerization.

25. The aqueous polymer dispersion according to any of claims 17 to 24, the average particle diameter of the polymer particles, determined by light scattering, being situated in the range from 0.03 to 1.5 μm.

26. The aqueous polymer dispersion according to any of claims 17 to 25, the water-insoluble polymer having a glass transition temperature in the range from −60 to +60° C.

27. A solid pulverulent binder composition obtainable by drying an aqueous polymer dispersion according to any of claims 17 to 26 to give a powder, and then mixing the powder with solid boric acid or a salt of boric acid.

28. The use of a binder composition according to any of claims 1 to 15 and 27 in a coating material, adhesive or sealant.

29. The use of a binder composition according to any of claims 1 to 15 and 27 in a printing ink.

30. The use of a binder composition according to any of claims 1 to 15 and 27 for producing a polymer-consolidated nonwoven.

31. The use of a binder composition according to any of claims 1 to 15 and 27 for modifying an inorganic, hydraulically setting binder.

32. A composition in the form of a coating material, adhesive or sealant, comprising a binder composition according to any of claims 1 to 15 and 27.

33. A polymer-consolidated nonwoven fabric, comprising a water-insoluble polymer according to any of claims 1 to 11 and boric acid or a salt of boric acid.

34. A hydraulically setting binder composition, comprising at least one inorganic, hydraulically setting binder and at least one binder composition according to any of claims 1 to 15 and 27.
